(19) United States
(12) Patent Application Publication
(10) Pub. No.: US 2025/0075016 A1
(43) Pub. Date: Mar. 6, 2025

(54) PELLETIZED ETHYLENE/a-OLEFIN COPOLYMER PRODUCT

(71) Applicant: NOVA CHEMICALS (INTERNATIONAL) S.A., Fribourg (CH)

(72) Inventors: Soheil SADEGHI, Calgary (CA); Abolfazl NOORJAHAN, Calgary (CA); Stephen BROWN, Calgary (CA); Marcia PIRES FORTES FERREIRA, Calgary (CA); Mehrnaz RAHIMI, Calgary (CA); Jun WANG, Calgary (CA)

(73) Assignee: NOVA CHEMICALS (INTERNATIONAL) S.A., Fribourg (CH)

(21) Appl. No.: 18/721,002

(22) PCT Filed: Dec. 13, 2022
(86) PCT No.: PCT/IB2022/062137

§ 371 Date: Jun. 17, 2024

Related U.S. Application Data
(60) Provisional application No. 63/292,343, filed on Dec. 21, 2021.

(51) Int. Cl. C08F 210/16; C08F 2/00; C08F 2/06; C08F 4/6592; C08J 3/12

(52) U.S. Cl. CPC C08F 210/16; C08F 2/001; C08F 2/06; C08F 4/65927; C08J 3/12; C08J 2323/08

(57) ABSTRACT

The present disclosure describes ethylene/α-olefin copolymer products with a density from 0.865 to 0.905 g/cm³ characterized as having unique rheological fingerprint during their transition from a solid state into a fully molten state. The ethylene/α-olefin copolymer products comprise a first high-density fraction and optionally a second high-density fraction. wherein said first and said optional second high-density fractions have distinct chemical compositions from that of the overall ethylene/α-olefin copolymer products. The first high-density fraction further has a weight-average molecular weight M_{w,1}^{HD}, wherein M_{w,1}^{HD} and the weight average molecular weight of the overall ethylene/α-olefin copolymer product M_{w} satisfy the inequality of M_{w,1}^{HD}/M_{w}>2.

### TECHNICAL FIELD

Provided herein is an ethylene/α-olefin copolymer product with a unique rheological fingerprint during transition from a solid state into a fully molten state. The pelletized product prepared from the ethylene/α-olefin copolymer product has a delayed softening behavior which enables the devolatilization of the pelletized product at a higher temperature, and thus results into a significantly reduced operating cost by decreasing the holdup time required to reach a target level of residual volatile hydrocarbons.

### BACKGROUND ART

Devolatilization using a stripping agent such as air, nitrogen, gaseous hydrocarbon, etc. is a known technique for the removal of volatile hydrocarbon residues (e.g., unreacted monomers) from solid polymer particles. It is known to those of ordinary experience that it is desired to heat the polymer particles to accelerate the desorption process of hydrocarbon residues and to reduce the holdup time required to strip the polymer particles form hydrocarbon residues. However, for a given polymer composition, there is an upper limit for the devolatilization temperature above which polymer particles start softening and forming agglomerates which may plug the devolatilization unit. As a result, to enable devolatilization at an accelerated rate, there is still a need to develop polymer compositions with delayed softening and deformation under devolatilization conditions to postpone the onset of polymer particles agglomerates formation.

### SUMMARY OF INVENTION

Provided in one embodiment of this disclosure is an ethylene/α-olefin copolymer product having:
(a) a density from 0.865 to 0.905 g/cm³ as measured by ASTM D1505;
(b) a melt index MI₂ from 0.3 to 1.5 dg/min as measured by ASTM D1238 at a temperature of 190° C. using a 2.16 kg load;
(c) a weight-average molecular weight M_{w} of from 95 to 140 kg/mol as measured by conventional size exclusion chromatography; and
(d) a z-average molecular weight M_{z} of 220 to 280 kg/mol as measured by conventional size exclusion chromatography;
wherein said ethylene/α-olefin copolymer product comprises from 0.5 to 2 weight percent of a first high-density fraction characterized as having:
   i) a ΔSCB₁ of less than −10 branch point per 1000 carbons, wherein said ΔSCB₁ is defined according to SCB₁^{HD}−SCB, wherein SCB₁^{HD} is a short chain branching content of said first high-density fraction and SCB is an overall short chain branching content of said ethylene/α-olefin copolymer product as measured by Fourier transform infrared (FTIR) spectroscopy according to ASTM D6645-01 (2001); and
   ii) a weight-average molecular weight M_{w,1}^{HD}, wherein said weight-average molecular weight of said first high-density fraction M_{w,1}^{HD} and said weight average molecular weight of said ethylene/α-olefin copolymer product M_{w} satisfy the inequality of M_{w,1}^{HD}/M_{w}>2.

In an embodiment, said short chain branching content SCB₁^{HD} of said first high-density fraction and said weight-average molecular weight M_{w,1}^{HD} of said first high-density fraction, respectively, satisfy the inequalities of ΔSCB₁>−20 branch point per 1000 carbons and M_{w,1}^{HD}/M_{w}<3.

In an embodiment, said ethylene/α-olefin copolymer product comprises from 0.3 to 0.8 weight percent of a second high-density fraction characterized as having:
i) a ΔSCB₂ of less than −10 branch point per 1000 carbons, wherein said ΔSCB₂ is defined according to SCB₂^{HD}-SCB, wherein SCB₂^{HD} is a short chain branching content of said second high-density fraction and SCB is said overall short chain branching content of said ethylene/α-olefin copolymer product as measured by Fourier transform infrared (FTIR) spectroscopy according to ASTM D6645-01 (2001); and
ii) a weight-average molecular weight M_{w,2}^{HD}, wherein said weight-average molecular weight of said second high-density fraction M_{w,2}^{HD} and said weight average molecular weight of said ethylene/α-olefin copolymer product M_{w} satisfies the inequality of 0.8<M_{w,2}^{HD}/M_{w}<1.2.

In an embodiment, said ethylene/α-olefin copolymer product has a rheological softening point (RSP) from greater than or equal to 55° C. to less than or equal to 95° C., wherein said ethylene/α-olefin copolymer product comprises the following crystalline fractions in a dynamic temperature sweep test:
(a) from about 1 percent to about 3 percent of a crystalline fraction melting in the temperature range from 50° C. to the RSP of said ethylene/α-olefin copolymer product;
(b) from 60 percent to 80 percent of a crystalline fraction melting in the temperature range from the RSP of said ethylene/α-olefin copolymer product to RSP+40° C.; and
(c) from 15 percent to 30 percent of a crystalline fraction melting in the temperature range from RSP+40° C. to RSP+70° C.

In an embodiment, said ethylene/α-olefin copolymer product has a rheological softening point (RSP) from greater than or equal to 55° C. to less than or equal to 95° C., wherein said ethylene/α-olefin copolymer product comprises the following crystalline fractions in a dynamic temperature sweep test:
(a) from about 1 percent to about 5 percent of a crystalline fraction melting in the temperature range from 50° C. to the RSP of said ethylene/α-olefin copolymer product;
(b) from 60 percent to 80 percent of a crystalline fraction melting in the temperature range from the RSP of said ethylene/α-olefin copolymer product to RSP+40° C.; and
(c) from 10 percent to 20 percent of a crystalline fraction melting in the temperature range from RSP+40° C. to RSP+70° C.

In an embodiment, said ethylene/α-olefin copolymer product has a density of less than or equal to 0.902 g/cm³ as measured by ASTM D1505.

In an embodiment, said ethylene/α-olefin copolymer product has a density of less than or equal to 0.900 g/cm³ as measured by ASTM D1505.

In an embodiment, said ethylene/α-olefin copolymer product has a melt index MI₂ from 0.3 to 0.8 dg/min as measured by ASTM D1238 at a temperature of 190° C. using a 2.16 kg load.

In an embodiment, said ethylene/α-olefin copolymer product is characterized as having a zero-shear viscosity (η₀) at 190° C. which satisfies the inequality of

$$log [ {{η}_{0} ( \frac{{M}_{z}}{{M}_{w}} )}^{0.4} ] - log ( {η}_{0}^{lin} ) > 0.156 ,$$

wherein M_{z}/M_{w} is the ratio of z-average molecular weight and weight-average molecular weight as determined by conventional size exclusion chromatography, and wherein log(η₀^{lin}) is defined according to the following double power-law equation:

$$log ( {η}_{0}^{lin} ) = α log ( {m}_{b} ) + β log ( {M}_{w}^{LS} ) + K$$

wherein α=−3.8326, β=3.6954, K=−10.3477, m_{b} is the molecular weight per backbone bond which is calculated in units of g/mol according to m_{b}=[n_{c}M_{w}^{como}+28(1−n_{c})]/2, wherein n_{c} is the mole fraction of the α-olefin comonomer measured by Fourier transform infrared (FTIR) spectroscopy according to ASTM D6645-01 (2001), M_{w}^{como} is the molecular weight of the α-olefin comonomer in g/mol, and M_{w}^{LS} is the absolute weight-average molecular weight as determined by light scattering size exclusion chromatography.

In an embodiment, said ethylene/α-olefin copolymer product is made in a continuous solution phase polymerization process with a single site catalyst system in two or more reactors, wherein said single site catalyst system comprises a metallocene catalyst having the formula (I):

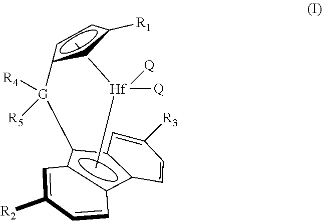

wherein G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In an embodiment, said ethylene/α-olefin copolymer product is blended with a high-density polyethylene to form a polymer blend comprising from 97 to 99.5 weight percent of the ethylene/α-olefin copolymer product and from 0.5 to 3 weight percent of the high-density polyethylene, wherein the high-density polyethylene has a density from 0.950 to 0.960 g/cm³ and a high load melt index (I₂₁) from 5 to 15 dg/min.

In an embodiment, the ethylene ethylene/α-olefin copolymer product and the high-density polyethylene, respectively, have complex viscosities |η*|¹ and |η*|² at a complex modulus |G*| of 10 kPa satisfying the inequality of 1< |η*|²/|η*|¹<10 or satisfying the inequality of 1< |η*|²/|η*|¹<8.

In an embodiment, the polymer blend comprises the following crystalline fractions in a dynamic temperature sweep test:
(a) from about 1 percent to about 3 percent of a crystalline fraction melting in the temperature range from 50° C. to the RSP of said polymer blend;
(b) from 60 percent to 80 percent of a crystalline fraction melting in the temperature range from the RSP of said polymer blend to RSP+40° C.; and
(c) from 15 percent to 30 percent of a crystalline fraction melting in the temperature range from RSP+40° C. to RSP+70° C.

Provided in one embodiment of this disclosure is a pelletized ethylene/α-olefin copolymer product comprising an ethylene/α-olefin copolymer product having:
(a) a density from 0.865 to 0.905 g/cm³ as measured by ASTM D1505;
(b) a melt index MI₂ from 0.3 to 1.5 dg/min as measured by ASTM D1238 at a temperature of 190° C. using a 2.16 kg load;
(c) a weight-average molecular weight M_{w} of from 95 to 140 kg/mol as measured by conventional size exclusion chromatography; and
(d) a z-average molecular weight M_{z} of 220 to 280 kg/mol as measured by conventional size exclusion chromatography;
wherein said ethylene/α-olefin copolymer product comprises from 0.5 to 2 weight percent of a first high-density fraction characterized as having:
   i) a ΔSCB₁ of less than −10 branch point per 1000 carbons, wherein said ΔSCB₁ is defined according to SCB₁^{HD}−SCB, wherein SCB₁^{HD} is a short chain branching content of said first high-density fraction and SCB is an overall short chain branching content of said ethylene/α-olefin copolymer product as measured by Fourier transform infrared (FTIR) spectroscopy according to ASTM D6645-01 (2001); and
   ii) a weight-average molecular weight M_{w,1}^{HD}, wherein said weight-average molecular weight of said first high-density fraction M_{w,1}^{HD} and said weight average molecular weight of said ethylene/α-olefin copolymer product M_{w} satisfy the inequality of M_{w,1}^{HD}/M_{w}>2.

In an embodiment, said pelletized ethylene/α-olefin copolymer product comprises an ethylene/α-olefin copolymer product, wherein said ethylene/α-olefin copolymer product comprises a first high-density fraction characterized as having a short chain branching content SCB₁^{HD} and a weight-average molecular weight M_{w,1}^{HD}, which respectively, satisfy the inequalities of SCB₁^{HD}−SCB>−20 and M_{w,1}^{HD}/M_{w}<3.

In an embodiment, said pelletized ethylene/α-olefin copolymer product comprises an ethylene/α-olefin copolymer product, wherein said ethylene/α-olefin copolymer product comprises from 0.4 to 0.8 weight percent of a second high-density fraction characterized as having:
i) a ΔSCB₂ of less than −10 branch point per 1000 carbons, wherein said ΔSCB₂ is defined according to SCB₂^{HD}−SCB, wherein SCB₂^{HD} is a short chain branching content of said second high-density fraction and SCB is said overall short chain branching content of said ethylene/α-olefin copolymer product as measured by Fourier transform infrared (FTIR) spectroscopy according to ASTM D6645-01 (2001); and
ii) a weight-average molecular weight M_{w,2}^{HD}, wherein said weight-average molecular weight of said second high-density fraction M_{w,2}^{HD} and said weight average molecular weight of said ethylene/α-olefin copolymer product M_{w} satisfies the inequality of 0.8<M_{w,2}^{HD}/M_{w}<1.2.

In an embodiment, said pelletized ethylene/α-olefin copolymer product comprises an ethylene/α-olefin copolymer product, wherein said ethylene/α-olefin copolymer product has a rheological softening point (RSP) from greater than or equal to 55° C. to less than or equal to 95° C., wherein said ethylene/α-olefin copolymer product comprises the following crystalline fractions in a dynamic temperature sweep test:
(a) from about 1 percent to about 5 percent of a crystalline fraction melting in the temperature range from 50° C. to the RSP of said ethylene/α-olefin copolymer product;
(b) from 60 percent to 80 percent of a crystalline fraction melting in the temperature range from the RSP of said ethylene/α-olefin copolymer product to RSP+40° C.; and
(c) from 10 percent to 20 percent of a crystalline fraction melting in the temperature range from RSP+40° C. to RSP+70° C.

In an embodiment, said pelletized ethylene/α-olefin copolymer product comprises an ethylene/α-olefin copolymer product, wherein said ethylene/α-olefin copolymer product has a density of less than or equal to 0.902 g/cm³ as measured by ASTM D1505.

In an embodiment, said pelletized ethylene/α-olefin copolymer product comprises an ethylene/α-olefin copolymer product, wherein said ethylene/α-olefin copolymer product has a density of less than or equal to 0.900 g/cm³ as measured by ASTM D1505.

In an embodiment, said pelletized ethylene/α-olefin copolymer product comprises an ethylene/α-olefin copolymer product, wherein said ethylene/α-olefin copolymer product has a melt index MI₂ from 0.3 to 0.8 dg/min as measured by ASTM D1238 at a temperature of 190° C. using a 2.16 kg load.

In an embodiment, said pelletized ethylene/α-olefin copolymer product comprises an ethylene/α-olefin copolymer product, wherein said ethylene/α-olefin copolymer product is characterized as having a zero-shear viscosity (η₀) at 190° C. which satisfies the inequality of

$$log [ {{η}_{0} ( \frac{{M}_{z}}{{M}_{w}} )}^{0.4} ] - log ( {η}_{0}^{lin} ) > 0.156 ,$$

wherein M_{z}/M_{w} is the ratio of z-average molecular weight and weight-average molecular weight as determined by conventional size exclusion chromatography, and wherein log(η₀^{lin}) is defined according to the following double power-law equation:

$$log ( {η}_{0}^{lin} ) = α log ( {m}_{b} ) + β log ( {M}_{w}^{LS} ) + K$$

wherein α=−3.8326, β=3.6954, K=−10.3477, m_{b} is the molecular weight per backbone bond which is calculated in units of g/mol according to m_{b}=[n_{c}M_{w}^{como}+28(1−n_{c})]/2, wherein n_{c} is the mole fraction of the α-olefin comonomer measured by Fourier transform infrared (FTIR) spectroscopy according to ASTM D6645-01 (2001), M_{w}^{como} is the molecular weight of the α-olefin comonomer in g/mol, and M_{w}^{LS} is the absolute weight-average molecular weight as determined by light scattering size exclusion chromatography.

### BRIEF DESCRIPTION OF THE FIGURES

FIGS. 1a and 1b show the non-isothermal crystallization profiles of the ethylene/α-olefin copolymer product in Examples 1-3 as well as the Comparative Example 1-3 at a cooling rate of 10° C. per minute.

FIGS. 2a through 2e show the temperature dependence of the elastic shear modulus within a temperature range from 50° C. to 130° C. for Example 1 and Comparative Examples 1 through 4. The first-order log-derivative of the elastic shear modulus is also included for these Examples together with the fitted sum of Gaussian functions (the solid line) and individual Gaussian terms (the dotted lines) fitted to the first-order log-derivative function.

FIG. 3 shows variation in the normalized change in the gap height as a function of temperature under a constant consolidation pressure on the pellets of Example 1P and Comparative Examples 1P through 4P.

### DEFINITIONS

In order to form a more complete understanding of this disclosure the following terms are defined and should be used with the accompanying figures and the description of the various embodiments throughout.

As used herein, the term “monomer” refers to a small molecule that may chemically react and become chemically bonded with itself or other monomers to form a polymer.

As used herein, the term “α-olefin” is used to describe a monomer having a linear hydrocarbon chain containing from 3 to 20 carbon atoms having a double bond at one end of the chain; an equivalent term is “linear α-olefin”. As used herein, the term “polyethylene” or “ethylene polymer”, refers to macromolecules produced from ethylene monomers and optionally one or more additional monomers; regardless of the specific catalyst or specific process used to make the ethylene polymer. In the polyethylene art, the one or more additional monomers are called “comonomer(s)” and often include α-olefins. The term “homopolymer” refers to a polymer that contains only one type of monomer. An “ethylene homopolymer” is made using only ethylene as a polymerizable monomer. The term “copolymer” refers to a polymer that contains two or more types of monomer. An “ethylene/α-olefin copolymer” is made using ethylene and one or more other types of polymerizable monomer (e.g., an α-olefin).

Common polyethylenes include high-density polyethylene (HDPE), medium density polyethylene (MDPE), linear low-density polyethylene (LLDPE), very low-density polyethylene (VLDPE), ultralow density polyethylene (ULDPE), plastomers and elastomers. The term polyethylene also includes polyethylene terpolymers which may include two or more comonomers (e.g., α-olefins) in addition to ethylene. The term polyethylene also includes combinations of, or blends of, the polyethylenes described above.

As used herein, the terms “linear high-density polyethylene” refers to a polyethylene homopolymer or, more preferably, an ethylene/α-olefin copolymer having a density of from about 0.945 g/cm³ to about 0.970 g/cm³.

As used herein, the term “high-density fraction” refers to a fraction in a copolymer composition having a chemical composition distinct from that of the other fractions present in the copolymer composition. The term “chemical composition” specifically refers to the number of short chain branches (SCB) per 1000 backbone carbons present in each fraction of said copolymer composition. It is plain that the “high-density fraction” has a number of short chain branches (SCB) per 1000 backbone carbons distinct from and less than that of the other fractions present in the copolymer composition.

As used herein, the terms “hydrocarbyl”, “hydrocarbyl radical” or “hydrocarbyl group” refers to linear or cyclic, aliphatic, olefinic, acetylenic and aryl (aromatic) radicals comprising hydrogen and carbon that are deficient by one hydrogen.

As used herein, an “alkyl radical” includes linear, branched, and cyclic paraffin radicals that are deficient by one hydrogen radical; non-limiting examples include methyl (—CH₃) and ethyl (—CH₂CH₃) radicals. The term “alkenyl radical” refers to linear, branched, and cyclic hydrocarbons containing at least one carbon-carbon double bond that is deficient by one hydrogen radical.

As used herein, the term “aryl” group includes phenyl, naphthyl, pyridyl and other radicals whose molecules have an aromatic ring structure; non-limiting examples include naphthylene, phenanthrene and anthracene. An “arylalkyl” group is an alkyl group having an aryl group pendant there from; non-limiting examples include benzyl, phenethyl and tolylmethyl. An “alkylaryl” is an aryl group having one or more alkyl groups pendant there from; non-limiting examples include tolyl, xylyl, mesityl and cumyl.

An “alkoxy” group is an oxy group having an alkyl group pendant there from and includes for example a methoxy group, an ethoxy group, an iso-propoxy group and the like.

An “aryloxy” or “aryl oxide” group is an oxy group having an aryl group pendant there from and includes for example a phenoxy group and the like.

As used herein, the phrase “heteroatom” includes any atom other than carbon and hydrogen that can be bound to carbon. A “heteroatom-containing group” is a hydrocarbon radical that contains a heteroatom and may contain one or more of the same or different heteroatoms. In one embodiment, a heteroatom-containing group is a hydrocarbyl group containing from 1 to 3 atoms selected from the group consisting of boron, aluminum, silicon, germanium, nitrogen, phosphorous, oxygen and sulfur. Non-limiting examples of heteroatom-containing groups include radicals of imines, amines, oxides, phosphines, ethers, ketones, oxoazolines heterocyclics, oxazolines, thioethers, and the like. The term “heterocyclic” refers to ring systems having a carbon backbone that comprise from 1 to 3 atoms selected from the group consisting of boron, aluminum, silicon, germanium, nitrogen, phosphorous, oxygen and sulfur.

As used herein the term “unsubstituted” means that hydrogen radicals are bounded to the molecular group that follows the term unsubstituted. The term “substituted” means that the group following this term possesses one or more moieties (nonhydrogen radicals) that have replaced one or more hydrogen radicals in any position within the group; non-limiting examples of moieties include halogen radicals (F, Cl, Br), hydroxyl groups, carbonyl groups, carboxyl groups, silyl groups, amine groups, phosphine groups, alkoxy groups, phenyl groups, naphthyl groups, C₁ to C₃₀ alkyl groups, C₂ to C₃₀ alkenyl groups, and combinations thereof. Non-limiting examples of substituted alkyls and aryls include: acyl radicals, alkyl silyl radicals, alkylamino radicals, alkoxy radicals, aryloxy radicals, alkylthio radicals, dialkylamino radicals, alkoxycarbonyl radicals, aryloxycarbonyl radicals, carbomoyl radicals, alkyl-and dialkyl-carbamoyl radicals, acyloxy radicals, acylamino radicals, arylamino radicals and combinations thereof.

### DESCRIPTION OF EMBODIMENTS

### Ethylene/α-Olefin Copolymer Product

In the present disclosure, the ethylene/α-olefin copolymer product will comprise a first high-density fraction which has a weight-average molecular weight M_{w,1}^{HD} and a short chain branching content (SCB₁^{HD}) distinct from those of the overall ethylene/α-olefin copolymer product.

In the present disclosure, the ethylene/α-olefin copolymer product will have a Tₒₙₛₑₜ−Tₘₐₓ of at least 20° C., wherein Tₘₐₓ is the peak crystallization temperature (i.e., an exothermic peak with the maximum heat flow) during a first cooling cycle from melt at a cooling rate of 10 K/min in a DSC experiment and Tₒₙₛₑₜ is the onset of crystallization defined according to the onset point where the heat producing DSC signal left the high-temperature baseline during said first cooling cycle at a cooling rate of 10 K/min in said DSC experiment. The first cooling thermogram of the ethylene/α-olefin copolymer product will further contain an intermediate exothermic peak (with a heat flow smaller than that of the Tₘₐₓ) at a temperature between Tₒₙₛₑₜ and Tₘₐₓ.

In an embodiment, the ethylene/α-olefin copolymer product comprises from 0.5 to 2 weight percent of the first high-density fraction. In an embodiment, the ethylene/α-olefin copolymer product comprises from 0.8 to 2 weight percent of the first high-density fraction. In an embodiment, the ethylene/α-olefin copolymer product comprises from 1 to 2 weight percent of the first high-density fraction. In an embodiment, the ethylene/α-olefin copolymer product comprises from 1.5 to 2 weight percent of the first high-density fraction.

In an embodiment, the short chain branching content of the first high-density fraction (SCB₁^{HD}) is distinct from and less than the overall short chain branching content (SCB) of the ethylene/α-olefin copolymer product. In an embodiment, the first high-density fraction is characterized as having a ΔSCB₁ of less than −10 branch point per 1000 carbons, wherein the ΔSCB₁ is defined according to SCB₁^{HD}−SCB. In an embodiment, the first high-density fraction is characterized as having a ΔSCB₁ of less than −12 branch point per 1000 carbons. In an embodiment, the first high-density fraction is characterized as having a ΔSCB₁ of less than −15 branch point per 1000 carbons. In an embodiment, the first high-density fraction is characterized as having a ΔSCB₁ of greater than −20 branch point per 1000 carbons.

The weight-average molecular weight of the first high-density fraction (M_{w,1}^{HD}) is distinct from and greater than the weight average molecular weight of said ethylene/α-olefin copolymer product (M_{w}). In an embodiment, M_{w,1}^{HD} and M_{w} satisfy the inequality of M_{w,1}^{HD}/M_{w}>2. In an embodiment, M_{w,1}^{HD} and M_{w} satisfy the inequality of M_{w,1}^{HD}/M_{w}>2.5. In an embodiment, M_{w,1}^{HD} and M_{w} satisfy the inequality of 2<M_{w,1}^{HD}/M_{w}<3. In an embodiment, M_{w,1}^{HD} and M_{w} satisfy the inequality of 2.3<M_{w,1}^{HD}/M_{w}<3. In an embodiment, M_{w,1}^{HD} and M_{w} satisfy the inequality of 2.5<M_{w,1}^{HD}/M_{w}<3.

In an embodiment, the ethylene/α-olefin copolymer product comprises a second high-density fraction characterized as having a short chain branching content (SCB₂^{HD}) distinct from and less than the overall short chain branching content (SCB) of the ethylene/α-olefin copolymer product; and a weight-average molecular weight M_{w,2}^{HD} indistinct from that of the ethylene/α-olefin copolymer product.

In an embodiment, the ethylene/α-olefin copolymer product comprises from 0.3 to 0.8 weight percent of the second high-density fraction. In an embodiment, the ethylene/α-olefin copolymer product comprises from 0.3 to 0.7 weight percent of the second high-density fraction. In an embodiment, the ethylene/α-olefin copolymer product comprises from 0.3 to 0.6 weight percent of the second high-density fraction.

In an embodiment, the second high-density fraction is characterized as having a ΔSCB₂ of less than −10 branch point per 1000 carbons, wherein the ΔSCB₂ is defined according to SCB₂^{HD}−SCB. In an embodiment, the second high-density fraction is characterized as having a ΔSCB₂ of less than −12 branch point per 1000 carbons. In an embodiment, the second high-density fraction is characterized as having a ΔSCB₂ of greater than −20 branch point per 1000 carbons. In an embodiment, the second high-density fraction is characterized as having a ΔSCB₂ of greater than −18 branch point per 1000 carbons.

In an embodiment, M_{w,2}^{HD} and M_{w} satisfy the inequality of 0.8<M_{w,2}^{HD}/M_{w}<1.2. In an embodiment, M_{w,2}^{HD} and M_{w} satisfy the inequality of 0.9<M_{w,2}^{HD}/M_{w}<1.1. In an embodiment, M_{w,2}^{HD} and M_{w} satisfy the inequality of 0.95<M_{w,1}^{HD}/M_{w}<1.05.

In embodiments of the present disclosure, the ethylene/α-olefin copolymer product is made in a continuous solution phase polymerization process with a single site catalyst system in two or more reactors.

In an embodiment, the ethylene/α-olefin copolymer product of the present disclosure is made in a continuous solution phase polymerization process by polymerizing ethylene and an α-olefin with a single site catalyst system in presence of a process solvent in two or more reactors, where the two or more reactors are configured in series with one another.

In an embodiment, the ethylene/α-olefin copolymer product of the present disclosure is made in a continuous solution phase polymerization process by polymerizing ethylene and an α-olefin with a single site catalyst system in presence of a process solvent in a first, a second, and a third reactor, where the first reactor, the second reactor and the third reactor are configured in series to one another, and where the first reactor, the second reactor and the third reactor are selected from a group consisting of a continuously stirred tank reactor and a tubular reactor.

In an embodiment, the ethylene/α-olefin copolymer product of the present disclosure is made in a continuous solution phase polymerization process by polymerizing ethylene and an α-olefin with a single site catalyst system in presence of a process solvent in a first continuously stirred tank reactor, a second continuously stirred tank reactor, and a first tubular reactor, where the first continuously stirred tank reactor, the second continuously stirred tank reactor, and the first tubular reactor are configured in series to one another where the effluent of the first continuously stirred tank reactor is fed to the second continuously stirred tank reactor, and the effluent of the second continuously stirred tank reactor is fed to the first tubular reactor.

In an embodiment, the second continuously stirred tank reactor is operated at different operating conditions relative to the first continuously stirred tank reactor, where the operating conditions are selected from a group consisting of an agitation speed, a composition of fresh feed fed to the second continuously stirred tank reactor, a temperature of fresh feed fed to the second continuously stirred tank reactor, a feed rate of fresh feed fed to the second continuously stirred tank reactor, and any combination thereof.

In an embodiment of the disclosure, the ethylene/α-olefin copolymer product is made with a bridged metallocene catalyst having the formula I:

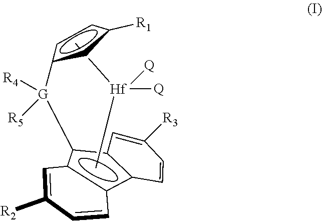

wherein G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In an embodiment, R₄ and R₅ are independently an aryl group. In an embodiment, R₄ and R₅ are independently a phenyl group or a substituted phenyl group. In an embodiment, R₄ and R₅ are a phenyl group. In an embodiment, R₄ and R₅ are independently a substituted phenyl group. In an embodiment, R₄ and R₅ are a substituted phenyl group, wherein the phenyl group is substituted with a substituted silyl group. In an embodiment, R₄ and R₅ are a substituted phenyl group, wherein the phenyl group is substituted with a trialkyl silyl group. In an embodiment, R₄ and R₅ are a substituted phenyl group, wherein the phenyl group is substituted at the para position with a trialkylsilyl group. In an embodiment, R₄ and R₅ are a substituted phenyl group, wherein the phenyl group is substituted at the para position with a trimethylsilyl group. In an embodiment, R₄ and R₅ are a substituted phenyl group, wherein the phenyl group is substituted at the para position with a triethylsilyl group. In an embodiment, R₄ and R₅ are independently an alkyl group. In an embodiment, R₄ and R₅ are independently an alkenyl group. In an embodiment, R₁ is hydrogen. In an embodiment, R₁ is an alkyl group. In an embodiment, R₁ is an aryl group. In an embodiment, R₁ is an alkenyl group.

In an embodiment, R₂ and R₃ are independently a hydrocarbyl group having from 1 to 30 carbon atoms. In an embodiment, R₂ and R₃ are independently an aryl group. In an embodiment, R₂ and R₃ are independently an alkyl group. In an embodiment, R₂ and R₃ are independently an alkyl group having from 1 to 20 carbon atoms. In an embodiment, R₂ and R₃ are independently a phenyl group or a substituted phenyl group. In an embodiment, R₂ and R₃ are a tert-butyl group. In an embodiment, R₂ and R₃ are hydrogen. In an embodiment of the disclosure, the ethylene/α-olefin copolymer product is made with a bridged metallocene catalyst having the formula II:

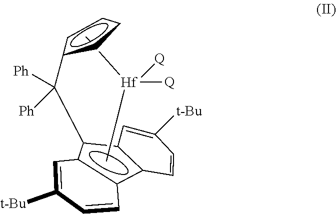

wherein Q is independently an activatable leaving group ligand. In the current disclosure, the term “activatable”, means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g. a halide may be converted to an alkyl group). Without wishing to be bound by any single theory, protonolysis or abstraction reactions generate an active “cationic” metal center which can polymerize olefins.

In embodiments of the present disclosure, the activatable ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀ aryl or aryloxy; an amido or a phosphido radical, but where Q is not a cyclopentadienyl. Two Q ligands may also be joined to one another and form for example, a substituted or unsubstituted diene ligand (e.g. 1,3-butadiene); or a delocalized heteroatom containing group such as an acetate or acetamidinate group.

In an embodiment of the disclosure, each Q is independently selected from the group consisting of a halide atom, a C₁₋₄ alkyl radical and a benzyl radical. In an embodiment, suitable activatable ligands, Q are monoanionic such as a halide (e.g., chloride) or a hydrocarbyl (e.g., methyl, benzyl).

In an embodiment, each activatable ligand, Q is a methyl group. In an embodiment, each activatable ligand, Q is a benzyl group. In an embodiment, each activatable ligand, Q is a chloride group. In an embodiment of the disclosure, the single site catalyst used to make the ethylene/α-olefin copolymer is diphenylmethylene(cyclopentadienyl)(2,7-di-t-butylfluorenyl)hafnium dichloride having the molecular formula: [(2,7-tBu₂Flu)Ph₂C(Cp)HfCl₂].

In an embodiment of the disclosure the single site catalyst used to make the ethylene/α-olefin copolymer is diphenylmethylene(cyclopentadienyl)(2,7-di-t-butylfluorenyl)hafnium dimethyl having the molecular formula [(2,7-tBu₂Flu)Ph₂C(Cp)HfMe₂]. In addition to the single site catalyst molecule per se, an active single site catalyst system typically further comprises a catalyst activator. In an embodiment of the disclosure, a catalyst activator comprises an alkylaluminoxane and/or an ionic activator.

A catalyst activator may also optionally include a hindered phenol compound.

In an embodiment of the disclosure, a catalyst activator comprises an alkylaluminum, an ionic activator and a hindered phenol compound. Although the exact structure of alkylaluminoxane is uncertain, subject matter experts generally agree that it is an oligomeric species that contain repeating units of the general formula: (R)₂AlO—(Al(R)—O)ₙ—Al(R)₂ where the R groups may be the same or different linear, branched or cyclic hydrocarbyl radicals containing 1 to 20 carbon atoms and n is from 0 to about 50. A non-limiting example of an alkylaluminoxane is methylaluminoxane (or MAO) wherein each R group is a methyl radical.

In an embodiment of the disclosure, R of the alkylaluminoxane, is a methyl radical and m is from 10 to 40. In an embodiment of the disclosure, the alkylaluminoxane is modified methylaluminoxane (MMAO).

It is well known in the art, that the alkylaluminoxane can serve dual roles as both an alkylator and an activator. Hence, an alkylaluminoxane catalyst activator is often used in combination with activatable ligands such as halogens.

In general, ionic activators are comprised of a cation and a bulky anion; wherein the latter is substantially non-coordinating. Non-limiting examples of ionic activators are boron ionic activators that are four coordinate with four ligands bonded to the boron atom. Non-limiting examples of boron ionic activators include the following formulas shown below:

[R⁵]⁺[B(R⁷)₄]⁻

where B represents a boron atom, R⁵ is an aromatic hydrocarbyl (e.g., triphenyl methyl cation) and each R⁷ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula —Si(R⁹)₃, where each R⁹ is independently selected from hydrogen atoms and C₁₋₄ alkyl radicals, and

[(R⁸)ₜZH]⁺[B(R⁷)₄]⁻

where B is a boron atom, H is a hydrogen atom, Z is a nitrogen or phosphorus atom, t is 2 or 3 and R⁸ is selected from C₁₋₈ alkyl radicals, phenyl radicals which are unsubstituted or substituted by up to three C₁₋₄ alkyl radicals, or one R⁸ taken together with the nitrogen atom may form an anilinium radical and R⁷ is as defined above.

In both formula a non-limiting example of R⁷ is a pentafluorophenyl radical. In general, boron ionic activators may be described as salts of tetra(perfluorophenyl) boron; non-limiting examples include anilinium, carbonium, oxonium, phosphonium and sulfonium salts of tetra(perfluorophenyl)boron with anilinium and trityl (or triphenylmethylium). Additional non-limiting examples of ionic activators include: triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra(o-tolyl)boron, N,N-dimethylanilinium tetra(phenyl)boron, N,N-diethylanilinium tetra(phenyl)boron, N,N-diethylanilinium tetra(phenyl)n-butylboron, N,N-2,4,6-pentamethylanilinium tetra(phenyl)boron, di-(isopropyl)ammonium tetra(pentafluorophenyl)boron, dicyclohexylammonium tetra(phenyl)boron, triphenylphosphonium tetra(phenyl)boron, tri(methylphenyl)phosphonium tetra(phenyl)boron, tri(dimethylphenyl)phosphonium tetra(phenyl)boron, tropillium tetrakispentafluorophenyl borate, triphenylmethylium tetrakispentafluorophenyl borate, benzene(diazonium)tetrakispentafluorophenyl borate, tropillium tetrakis(2,3,5,6-tetrafluorophenyl)borate, triphenylmethylium tetrakis(2,3,5,6-tetrafluorophenyl)borate, benzene(diazonium) tetrakis(3,4,5-trifluorophenyl)borate, tropillium tetrakis(3,4,5-trifluorophenyl)borate, benzene(diazonium) tetrakis(3,4,5-trifluorophenyl)borate, tropillium tetrakis(1,2,2-trifluoroethenyl)borate, triphenylmethylium tetrakis(1,2,2-trifluoroethenyl)borate, benzene(diazonium) tetrakis(1,2,2-trifluoroethenyl)borate, tropillium tetrakis(2,3,4,5-tetrafluorophenyl)borate, triphenylmethylium tetrakis(2,3,4,5-tetrafluorophenyl)borate, and benzene(diazonium) tetrakis(2,3,4,5tetrafluorophenyl)borate. Readily available commercial ionic activators include N,N-dimethylanilinium tetrakispentafluorophenyl borate, and triphenylmethylium tetrakispentafluorophenyl borate.

In an embodiment of the disclosure, the catalyst activator comprises an ionic activator selected from the group consisting of N,N-dimethylaniliniumtetrakispentafluorophenyl borate (“[Me₂NHPh][B(C₆F₅)₄]”); triphenylmethylium tetrakispentafluorophenyl borate (“[Ph₃C][B(C₆F₅)₄]”, also known as “trityl borate”); and trispentafluorophenyl boron. In an embodiment of the disclosure, the catalyst activator comprises triphenylmethylium tetrakispentafluorophenyl borate, “trityl borate”.

In embodiments of the disclosure, the catalyst activator comprises a hindered phenol compound selected from the group consisting of butylated phenolic antioxidants, butylated hydroxytoluene, 2,6-di-tertiarybutyl-4-ethyl phenol (BHEB), 4,4′-methylenebis (2,6-di-tertiary-butylphenol), 1,3, 5-trimethyl-2,4,6-tris (3,5-di-tert-butyl-4-hydroxybenzyl) benzene and octadecyl-3-(3′,5′-di-tert-butyl-4′-hydroxyphenyl) propionate.

In an embodiment of the disclosure, the catalyst activator comprises the hindered phenol compound, 2,6-di-tertiarybutyl-4-ethyl phenol (BHEB). Optionally, in embodiment of the disclosure, mixtures of alkylaluminoxanes and ionic activators can be used as catalyst activators, optionally together with a hindered phenol compound.

To produce an active single site catalyst system the quantity and mole ratios of the above components: the single site catalyst, the alkylaluminoxane, the ionic activator, and the optional hindered phenol are optimized.

In embodiments of the disclosure, the ionic activator compounds may be used in amounts which provide a molar ratio of hafnium, Hf (of the single site catalyst molecule) to boron that will be from 1:1 to 1:10, or from 1:1 to 1:6, or from 1:1 to 1:2. In embodiments of the disclosure, the mole ratio of aluminum contained in the alkylaluminoxane to the hafnium, Hf (of the single site catalyst molecule) will be from 5:1 to 1000:1, including narrower ranges within this range.

In embodiments of the disclosure, the mole ratio of aluminum contained in the alkylaluminoxane to the hindered phenol (e.g., BHEB) will be from 1:1 to 1:0.1, including narrower ranges withing this range.

To produce an active single site catalyst system the quantity and mole ratios of the three or four components: the single site catalyst, the alkylaluminoxane, the ionic activator, and the optional hindered phenol are optimized.

In solution phase polymerization, the monomers are dissolved/dispersed in the solvent either prior to being fed to the reactor (or for gaseous monomers the monomer may be fed to the reactor so that it will dissolve in the reaction mixture). Prior to mixing, the solvent and monomers are generally purified to remove potential catalyst poisons such as water, oxygen or metal impurities. The feedstock purification follows standard practices in the art, e.g., molecular sieves, alumina beds and oxygen removal catalysts are used for the purification of monomers. The solvent itself as well (e.g., methyl pentane, cyclohexane, hexane or toluene) is preferably treated in a similar manner.

The feedstock may be heated or cooled prior to feeding to the reactor. Generally, the catalyst components may be premixed in the solvent for the reaction or fed as separate streams to the reactor. In some instances, premixing it may be desirable to provide a reaction time for the catalyst components prior to entering the reaction. Such an “in line mixing” technique is described in a number of patents in the name of DuPont Canada Inc. (e.g., U.S. Pat. No. 5,589,555 issued Dec. 31, 1996).

Solution polymerization processes for the polymerization or copolymerization of ethylene are well known in the art (see for example U.S. Pat. Nos. 6,372,864 and 6,777,509). These processes are conducted in the presence of an inert hydrocarbon solvent. In a solution phase polymerization reactor, a variety of solvents may be used as the process solvent; non-limiting examples include linear, branched or cyclic C5 to C12 alkanes. Non-limiting examples of α-olefins include 1-propene, 1-butene, 1-pentene, 1-hexene and 1-octene. Suitable catalyst component solvents include aliphatic and aromatic hydrocarbons. Non-limiting examples of aliphatic catalyst component solvents include linear, branched or cyclic C5-12 aliphatic hydrocarbons, e.g. pentane, methyl pentane, hexane, heptane, octane, cyclohexane, cyclopentane, methylcyclohexane, hydrogenated naphtha or combinations thereof. Non-limiting examples of aromatic catalyst component solvents include benzene, toluene (methylbenzene), ethylbenzene, o-xylene (1,2-dimethylbenzene), m-xylene (1,3-dimethylbenzene), p-xylene (1,4-dimethylbenzene), mixtures of xylene isomers, hemellitene (1,2,3-trimethylbenzene), pseudocumene (1,2,4-trimethylbenzene), mesitylene (1,3,5-trimethylbenzene), mixtures of trimethylbenzene isomers, prehenitene (1,2,3,4-tetramethylbenzene), durene (1,2,3,5-tetramethylbenzene), mixtures of tetramethylbenzene isomers, pentamethylbenzene, hexamethylbenzene and combinations thereof.

The polymerization temperature in a conventional solution process may be from about 80° C. to about 300° C. In an embodiment of the disclosure the polymerization temperature in a solution process is from about 120° C. to about 250° C. The polymerization pressure in a solution process may be a “medium pressure process”, meaning that the pressure in the reactor is less than about 6,000 psi (about 42,000 kiloPascals or kPa). In an embodiment of the disclosure, the polymerization pressure in a solution process may be from about 10,000 to about 40,000 kPa, or from about 14,000 to about 22,000 kPa (i.e., from about 2,000 psi to about 3,000 psi).

Suitable monomers for copolymerization with ethylene include C₃₋₂₀ mono- and di-olefins. Preferred comonomers include C₃₋₁₂ alpha olefins which are unsubstituted or substituted by up to two C₁₋₆ alkyl radicals, C₈₋₁₂ vinyl aromatic monomers which are unsubstituted or substituted by up to two substituents selected from the group consisting of C₁₋₄ alkyl radicals, C₄₋₁₂ straight chained or cyclic diolefins which are unsubstituted or substituted by a C₁₋₄ alkyl radical. Illustrative non-limiting examples of such alphα-olefins are one or more of propylene, 1-butene, 1-pentene, 1-hexene, 1-octene and 1-decene, styrene, alpha methyl styrene, and the constrained-ring cyclic olefins such as cyclobutene, cyclopentene, dicyclopentadiene norbornene, alkyl-substituted norbornenes, alkenyl-substituted norbornenes and the like (e.g., 5-methylene-2-norbornene and 5-ethylidene-2-norbornene, bicyclo-(2,2,1)-hepta-2,5-diene).

In an embodiment of the disclosure, the ethylene/α-olefin copolymer product has from about 3 to about 12 mole percent of one or more than one alphα-olefin.

In an embodiment of the disclosure, the ethylene/α-olefin copolymer product has from about 3 to about 10 mole percent of one or more than one alphα-olefin.

In an embodiment of the disclosure, the ethylene/α-olefin copolymer product has from about 3.5 to about 10 mole percent of one or more than one alpha olefin.

In an embodiment of the disclosure, the ethylene/α-olefin copolymer product comprises ethylene and one or more than one alpha olefin selected from the group comprising 1-butene, 1-hexene, 1-octene and mixtures thereof.

In an embodiment of the disclosure, the ethylene/α-olefin copolymer product comprises ethylene and one or more than one alpha olefin selected from the group comprising 1-hexene, 1-octene and mixtures thereof.

In an embodiment of the disclosure, the ethylene/α-olefin copolymer product comprises ethylene and 1-octene.

In an embodiment of the disclosure, the ethylene/α-olefin copolymer product comprises ethylene and at least 1 mole percent 1-octene. In an embodiment of the disclosure, the ethylene/α-olefin copolymer product comprises ethylene and at least 3 mole percent 1-octene. In an embodiment of the disclosure, the ethylene/α-olefin copolymer product comprises ethylene and from 3 to 12 mole percent of 1-octene. In an embodiment of the disclosure, the ethylene/α-olefin copolymer product comprises ethylene and from 3 to 10 mole percent of 1-octene.

In an embodiment of the disclosure, the ethylene/α-olefin copolymer product of the present disclosure has a density of from 0.860 g/cm³ to 0.910 g/cm³. In an embodiment of the disclosure, the ethylene/α-olefin copolymer product of the present disclosure has a density of below 0.908 g/cm³. In an embodiment of the disclosure, the ethylene/α-olefin copolymer product of the present disclosure has a density of from 0.865 g/cm³ to 0.908 g/cm³. In another embodiment of the disclosure, the ethylene/α-olefin copolymer product of the present disclosure has a density of below 0.905 g/cm³. In another embodiment of the disclosure, the ethylene/α-olefin copolymer product of the present disclosure has a density of from 0.865 g/cm³ to below 0.905 g/cm³.

In an embodiment of the disclosure, the ethylene/α-olefin copolymer product of the present disclosure has a density of from 0.865 g/cm³ to 0.905 g/cm³, or from 0.870 g/cm³ to 0.905 g/cm³, or from 0.875 g/cm³ to 0.905 g/cm³, or from 0.880 g/cm³ to 0.905 g/cm³, or from 0.865 g/cm³ to 0.902 g/cm³, or from 0.870 g/cm³ to 0.902 g/cm³, or from 0.875 g/cm³ to 0.902 g/cm³, or from 0.865 g/cm³ to 0.900 g/cm³, or from 0.870 g/cm³ to 0.900 g/cm³, or from 0.875 g/cm³ to 0.900 g/cm³, or from 0.878 g/cm³ to 0.900 g/cm³.

In embodiments of the disclosure the melt index, I2 of the ethylene/α-olefin copolymer product may be from 0.1 dg/min to 2 dg/min, or from 0.1 dg/min to 1.5 dg/min, or from 0.3 dg/min to 1.5 dg/min, or from 0.3 dg/min to 1.0 dg/min, or from 0.3 dg/min to 0.9 dg/min, or from 0.3 dg/min to 0.8 dg/min.

In embodiments of the disclosure, the ethylene/α-olefin copolymer product has a weight-average molecular weight, M_{w} of from about 90,000 to about 200,000 g/mol, or from about 95,000 to about 150,000 g/mol, or from about 95,000 to about 140,000 g/mol, or from about 95,000 to about 125,000 g/mol, or from about 95,000 to about 120,000 g/mol.

In embodiments of the disclosure, the ethylene/α-olefin copolymer product has a lower limit molecular weight distribution, M_{w}/Mₙ of 1.8, or 2.0, or 2.1, or 2.2, or 2.3. In embodiments of the disclosure, the polyethylene composition has an upper limit molecular weight distribution, M_{w}/Mₙ of 6.0, or 5.5, or 5.0, or 4.5, or 4.0, or 3.75, or 3.5, or 3.0, or 2.5. In embodiments of the disclosure, the ethylene/α-olefin copolymer product has a molecular weight distribution, M_{w}/Mₙ of from 2.0 to 4.0, or from 2.5 to 4.0, or from 2.5 to 3.5.

In embodiments of the disclosure, the ethylene/α-olefin copolymer product has a z-average molecular weight, M_{z} of from about 200,000 to about 300,000 g/mol, or from about 220,000 to about 300,000 g/mol, or from about 220,000 to about 280,000 g/mol, or from about 220,000 to about 270,000 g/mol, or from about 220,000 to about 265,000 g/mol.

In embodiments of the disclosure, the ethylene/α-olefin copolymer product has a z-average molecular weight to weight-average molecular weight ratio, M_{z}/M_{w} of from 1.5 to 3.0, or from 1.5 to 2.5, or from 1.7 to 3.0, or from 1.7 to 2.5.

### Long Chain Branching in Ethylene/α-Olefin Copolymer Product

In embodiments of the disclosure, the ethylene/α-olefin copolymer product contains long chain branches, hereinafter ‘LCB’. LCB is a well-known structural phenomenon in ethylene/α-olefin copolymers and well known to those of ordinary skill in the art. In this disclosure, a long chain branch is macromolecular in nature, i.e., long enough to be seen in rheological experiments conducted on a molten sample.

In an embodiment, the zero-shear viscosity (η₀) of the ethylene/α-olefin copolymer product has a positive deviation from a double power-law relation of the form m_{b}^{α}M_{w}^{β}, wherein the m_{b}^{α} term is capable of introducing the impact of α-olefinic comonomer type and content independently of the molecular weight term M_{w}^{β}.

In an embodiment, the ethylene/α-olefin copolymer product is characterized as having a zero-shear viscosity (η₀) at 190° C. which satisfies the inequality of

$$log [ {{η}_{0} ( \frac{{M}_{z}}{{M}_{w}} )}^{0.4} ] - log ( {η}_{0}^{lin} ) > 0.156 ,$$

wherein M_{z}/M_{w} is the ratio of z-average molecular weight and weight-average molecular weight as determined by conventional SEC, and wherein log(η₀^{lin}) is defined according to the following double power-law equation:

$$log ( {η}_{0}^{lin} ) = α log ( {m}_{b} ) + β log ( {M}_{w}^{LS} ) + K \qquad ( eq \text{.1} )$$

wherein α=−3.8326, β=3.6954, K=−10.3477, m_{b} is the molecular weight per backbone bond which is calculated in units of g/mol according to m_{b}=[n_{c}M_{w}^{como}+28 (1−n_{c})]/2, wherein n_{c} is a mole fraction of the α-olefin measured by Fourier transform infrared (FTIR) spectroscopy according to ASTM D6645-01 (2001) and M_{w}^{como} is the molecular weight of the α-olefin comonomer in g/mol, and M_{w}^{LS} is the absolute weight-average molecular weight as determined by light scattering SEC.

The zero-shear viscosity (η₀) of the ethylene/α-olefin copolymer product is determined at 190° C. by fitting a 4-paramter Carreau-Yasuda viscosity model into the complex viscosity versus angular frequency defined by:

$$\vert {η}^{*} \vert = {{η}_{0} [ 1 + {( {τ}_{c} π )}^{a} ]}^{\frac{n - 1}{a}} \qquad ( eq \text{.2} )$$

in which |η*| is complex viscosity measured as a function of angular frequency ω, a is a parameter determining the breadth of transition from a Newtonian plateau to shear-thinning region with a slope of n−1 in a log-log plot. Detailed information regarding the applied DMA frequency sweep experiments at 190° C., used to obtain complex viscosity |η*| as a function of angular frequency ω, is fully described in the ‘Testing Methods’ section of this disclosure. In the present disclosure the parameter n is set to a constant value of 2/11 and rest of model parameters were fitted by a least square method.

In an embodiment, the ethylene/α-olefin copolymer product is characterized as having a zero-shear viscosity (η₀) at 190° C. which satisfies the inequality of

$$log [ {η}_{0} {( \frac{{M}_{z}}{{M}_{w}} )}^{0.4} ] - log ( {η}_{0}^{lin} ) > 0.18 .$$

In an embodiment, the ethylene/α-olefin copolymer product is characterized as having a zero-shear viscosity (η₀) at 190° C. which satisfies the inequality of

$$log [ {η}_{0} {( \frac{{M}_{z}}{{M}_{w}} )}^{0.4} ] - log ( {η}_{0}^{lin} ) > 0.54 .$$

In an embodiment, the ethylene/α-olefin copolymer product is characterized as having a zero-shear viscosity (η₀) at 190° C. which satisfies the inequality of

$$log [ {η}_{0} {( \frac{{M}_{z}}{{M}_{w}} )}^{0.4} ] - log ( {η}_{0}^{lin} ) > 0.67 .$$

In an embodiment, the ethylene/α-olefin copolymer product is characterized as having a zero-shear viscosity (η₀) at 190° C. which satisfies the inequality of

$$log [ {η}_{0} {( \frac{{M}_{z}}{{M}_{w}} )}^{0.4} ] - log ( {η}_{0}^{lin} ) > 0.89 .$$

In an embodiment, the ethylene/α-olefin copolymer product is characterized as having a zero-shear viscosity (η₀) at 190° C. which satisfies the inequality of

$$log [ {η}_{0} {( \frac{{M}_{z}}{{M}_{w}} )}^{0.4} ] - log ( {η}_{0}^{lin} ) < 2. .$$

In an embodiment, the ethylene/α-olefin copolymer product is characterized as having a zero-shear viscosity (η₀) at 190° C. which satisfies the inequality of

$$log [ {η}_{0} {( \frac{{M}_{z}}{{M}_{w}} )}^{0.4} ] - log ( {η}_{0}^{lin} ) < 1.8 .$$

In an embodiment, the ethylene/α-olefin copolymer product is characterized as having a zero-shear viscosity (η₀) at 190° C. which satisfies the inequality of

$$log [ {η}_{0} {( \frac{{M}_{z}}{{M}_{w}} )}^{0.4} ] - log ( {η}_{0}^{lin} ) < 1.8 .$$

### Linear Viscoelasticity During the Melting Interval

In an embodiment, the ethylene/α-olefin copolymer product has a rheological softening point (RSP in ° C.) which satisfies the following inequality:

$$6557.5 \times {ρ}^{2} - 10582 \times ρ + 4294 \leq R S P \leq 6557.5 \times {ρ}^{2} - 10582 \times ρ + 4304 \qquad ( eq . 3 )$$

wherein ρ is the ethylene/α-olefin copolymer product density in g/cm³ as measured by ASTM D1505.

In embodiments of the disclosure, the ethylene/α-olefin copolymer product has a rheological softening point (RSP) from greater than or equal to 55° C. to less than or equal to 95° C., or from greater than or equal to 55° C. to less than or equal to 90° C., or from greater than or equal to 55° C. to less than or equal to 85° C., or from greater than or equal to 55° C. to less than or equal to 80° C.

The rheological softening point (RSP) was determined using the absolute value of first-order log-derivative (slope) of elastic shear modulus data (|dlogG′/dT| in ° C.⁻¹) at a frequency of 1 rad/s and within a temperature range above 50° C., where the RSP is defined as the point with an absolute slope equal the geometric mean (S=\sqrt{SₘᵢₙSₘₐₓ}) of the minimum and maximum absolute slopes. The minimum slop (Sₘᵢₙ) is the absolute value of first-order log-derivative of elastic shear modulus (|dlogG′/dT|) at 50° C. The maximum slope (Sₘₐₓ) is the maximum absolute value of first-order log-derivative of elastic shear modulus (|dlogG′/dT|) observed within a temperature range from greater than 50° C. to less than 110° C. The elastic shear modulus at 1 rad/s is measured using multiple frequency temperature sweep test performed on rotational rheometer during melting interval at a heating rate of 0.5 K/min. Details regarding the applied test conditions are fully described in the ‘Testing Methods’ section of this disclosure.

Without wishing to be limited by any theory, the modulus slope at a given temperature is proportional with the apparent flow activation energy at that temperature. For the pre-softening region, the apparent activation energy is temperature-independent (Sₘᵢₙ, a constant G′ slope). The slope at the inflection point (Sₘₐₓ) marks the maximum apparent activation energy during the temperature softening process. Geometric mean of these slopes allows estimation of the onset of softening using an average apparent activation energy for a process with a largely variable rate of change.

In the present disclosure, the ethylene/α-olefin copolymer product will have a delayed softening behavior near and above its rheological softening point. In an embodiment, the ethylene/α-olefin copolymer product comprises from 1 percent to 5 percent of a fraction melting in the temperature range from 50° C. to the RSP of the ethylene/α-olefin copolymer product. In an embodiment, the ethylene/α-olefin copolymer product comprises from 3 percent to 5 percent of a fraction melting in the temperature range from 50° C. to the RSP of the ethylene/α-olefin copolymer product.

In an embodiment, the ethylene/α-olefin copolymer product comprises from 60 percent to 80 percent of a fraction melting in the temperature range from the RSP of said ethylene/α-olefin copolymer to RSP+40° C. In an embodiment, the ethylene/α-olefin copolymer product comprises from 65 percent to 80 percent of a fraction melting in the temperature range from the RSP of said ethylene/α-olefin copolymer to RSP+40° C. In an embodiment, the ethylene/α-olefin copolymer product comprises from 70 percent to 80 percent of a fraction melting in the temperature range from the RSP of said ethylene/α-olefin copolymer to RSP+40° C.

In an embodiment, the ethylene/α-olefin copolymer product comprises from 8 percent to 20 percent of a crystalline fraction melting in the temperature range from RSP+40° C. to RSP+70° C. In an embodiment, the ethylene/α-olefin copolymer product comprises from 10 percent to 20 percent of fraction melting in the temperature range from RSP+40° C. to RSP+70° C. In an embodiment, the ethylene/α-olefin copolymer product comprises from 12 percent to 20 percent of fraction melting in the temperature range from RSP+40° C. to RSP+70° C. In an embodiment, the ethylene/α-olefin copolymer product comprises from 16 percent to 20 percent of fraction melting in the temperature range from RSP+40° C. to RSP+70° C.

The percent of fractions melted in each one of the temperature intervals described in above embodiments are determined using a mathematical fitting routine involving Gaussian functions and error functions. In the present disclosure, the first-order log-derivative of elastic shear modulus data (|dlogG′/dT| in ° C.⁻¹) obtained at a frequency of 1 rad/s and at a heating rate of 0.5 K/min within a temperature range from 50° C. to 130° C. is fitted with a sum of n+2 or n+3 Gaussian functions, where n is the number of peaks observed in the |dlogG′/dT| function (in ° C.⁻¹) when plotted as a function of temperature (T in ° C.).

Each fitted Gaussian term (i.e., the i-th Gaussian term) has a mathematical form according to

$$\frac{{G}_{i}}{( {δ}_{i}^{T} \sqrt{2 π} )} exp \{ - {( T - {T}_{i}^{0} )}^{2} / [ 2 {( {δ}_{i}^{T} )}^{2} ] \}$$

wherein Gᵢ, δᵢ^{T} and Tᵢ⁰ are non-zero constants fitted by minimizing sum of squared residuals. One of the Gaussian terms with a δᵢ^{T}>15 specifically fits the pre-softening and post-melting regions of the |dlogG′/dT| function with a nearly temperature-independent value. In the next step, each Gaussian term (except the term having a δᵢ^{T}>15) is corresponded to an error function term to obtain the integrated area within any desired temperature interval above 50° C. and below 130° C. For example, the i-th Gaussian term has an integrated (cumulative) form according to

$$\frac{1}{2} [ 1 + erf ( \frac{T - {T}_{i}^{0}}{{δ}_{i}^{T} \sqrt{2}} ) ] .$$

The percent of fractions melted in each one of the temperature intervals of 50° C. to the RSP, RSP to RSP+40° C., and RSP+40° C. to RSP+70° C. are then calculated by summing the integrated area under each one the n+2 or n+3 Gaussian terms (excluding the term having a δᵢ^{T}>15) within the desired temperature interval and dividing it by the total area under the n+2 or n+3 Gaussian terms (excluding the term having a δᵢ^{T}>15) within the temperature range from 50° C. to 130° C.

### Polymer Blend

Among certain embodiments of the present disclosure is a polymer blend comprising the polyethylene/α-olefin copolymer product described herein and a high-density polyethylene.

In an embodiment, the polymer blend comprises from 0.5 weight percent to 3.0 weight percent of a high-density polyethylene. In an embodiment, the polymer blend comprises from 0.5 weight percent to 2.0 weight percent of a high-density polyethylene.

The polymer blend components may be blended using conventional mixing/blending equipment such as a single or twin sinew extruder; and internal batch mixer such as a BANBURY® mixer; or a continuous mixer such as a FARREL® mixer. The mixing time and temperatures may be readily optimized by those skilled in the art without undue experimentation. As a guideline, mixing temperatures of from about 150 to about 250° C. are suitable and mixing times of 1-20 minutes may provide satisfactory results.

A high-density polyethylene will in embodiments of the disclosure comprise at least 90 weight percent, or at least 95 weight percent, or at least 98 weight percent of ethylene with the balance being one or more than one α-olefins, selected from the group consisting of 1-butene, 1-hexene and 1-octene.

In an embodiment, the high-density polyethylene has a density from 0.950 to 0.960 g/cm³, or from 0.950 to 0.955 g/cm³, or from 0.950 to 0.953 g/cm³. In an embodiment, the high-density polyethylene has a high load melt index (I₂₁) from 5 to 15 dg/min, or from 8 to 12 dg/min, or from 8.5 to 11.5 dg/min.

An embodiment of the present disclosure includes a polymer blend comprising the ethylene/α-olefin copolymer product described herein and a high-density polyethylene, where the complex viscosity of the ethylene/α-olefin copolymer product (|η*|¹) and the complex viscosity of the high-density polyethylene (|η*|²) at a complex modulus (|G*|) of 10 kPa satisfy the inequality of 1< |η*|²/|η*|¹<10, or the inequality of 1< |η*|²/|η*|¹<8, or the inequality of 1< |η*|²/|η*|¹<6.

In an embodiment, the polymer blend has a rheological softening point (RSP in ° C.) which satisfies the following inequality:

$$6557 \text{.5} \times {ρ}_{B}^{2} - 10582 \times {ρ}_{B} + 4292 \leq R S P \leq 6557 \text{.5} \times {ρ}_{B}^{2} - 10582 \times {ρ}_{B} + 4304 \qquad ( eq . 4 )$$

wherein ρ_{B} is the polymer blend density in g/cm³ calculated given the linear specific volume blending rule and densities of the high-density polyethylene and the ethylene/α-olefin copolymer product, and the weight fractions thereof.

In an embodiment, the polymer blend comprises from 1 percent to 3 percent of a fraction melting in the temperature range from 50° C. to the RSP of the polymer blend.

In an embodiment, the polymer blend comprises from 60 percent to 80 percent (or from 60 percent to 75 percent) of a crystalline fraction melting in the temperature range from the RSP of the polymer blend to RSP+40° C.

In an embodiment, the polymer blend comprises from 15 percent to 30 percent (or from 20 percent to 30 percent) of a crystalline fraction melting in the temperature range from RSP+40° C. to RSP+70° C.

### Pelletized Ethylene/α-Olefin Copolymer Product

The ethylene/α-olefin copolymer product disclosed herein may be converted into a pelletized ethylene/α-olefin copolymer product. In an embodiment, the pelletized ethylene/α-olefin copolymer product is produced by feeding a molten stream of the ethylene/α-olefin copolymer product described herein to an extruder having a die plate at the extruder exit, where the die plate is configured with a plurality of circular holes, thereby leading to the formation of “spaghetti strands” of extrudate. These strands may be continuously cut by one or more rotating die plate cutters (which are also referred to as “knives” by those skilled in the art) to form the pellets. In an embodiment, a melt pump (also referred to as a gear pump) may be located between the exit of the extruder and the die plate to generate additional pressure without causing overheating. In an embodiment, the die plate cutters are water cooled. The pelletized ethylene/α-olefin copolymer products may contain greater than or equal to 1 weight % of residual volatile hydrocarbons (e.g., unreacted monomers) after the pelletization step.

The pellets are conveyed away from the die plate using water. The conventional water conveying system described above (i.e., a slurry of pellets in water being transferred through tubes) is used to move the pelletized ethylene/α-olefin copolymer product to a devolatilization unit and finishing operations. Water may be removed from the slurry using a conventional spin dryer prior to the devolatilization step. The water that is removed in the spin dryer may be returned to the die plate cutter for reuse/recycle. The “dry” pelletized ethylene/α-olefin copolymer product is then conveyed to a devolatilization unit for removal of the residual volatile hydrocarbons (e.g., unreacted monomers) down to a ppm level. In an embodiment, the devolatilization unit includes a single or multiple vessels each having a top end wall and a bottom end wall, and a continuous sidewall therebetween. A stripping agent (e.g., nitrogen gas) is continuously provided to a first area proximal the bottom end wall using a plurality of feed nozzles as an upward flow to the devolatilization vessel at a temperature, a flow rate and a duration of time sufficient to reduce the residual volatile hydrocarbons to a ppm level (e.g., less than or equal to 150 ppm) before discharging the pelletized ethylene/α-olefin copolymer product from the vessel(s).

The stripping agent is preferably provided to the first area proximal the bottom end wall of the vessel(s) at a temperature close to and below the rheological softening point (RSP) of the ethylene/α-olefin copolymer product (e.g., from 10° C. below the RSP of the ethylene/α-olefin copolymer product up to the RSP of the resin). Thus, to prevent formation of pellets agglomerates which will not readily flow and/or will plug the discharge system of the devolatilization vessel(s) and result in the shutdown of the production line, it is desired that the disclosed pelletized ethylene/α-olefin copolymer product has a delayed softening behavior. A delayed softening behavior is characterized as a delayed deformation of pellets under a consolidation pressure (e.g., the pressure exerted by a column of pellets located above any given point within the devolatilization vessel) at temperatures near the RSP of the resin. This delayed deformation will minimize the necking phenomenon and formation of adhesive contacts between neighboring pellets.

A delayed pellets deformation at temperatures near and above the RSP (e.g., from RSP to RSP+10° C.) can be further desirable in the cases where temperature drifts occur in the devolatilization vessel(s) during the devolatilization process.

In addition to above mentioned advantages, it is specially desired to operate the devolatilization vessel at a higher stripping agent inlet temperature to minimize the holdup time required to reach the target residual volatile hydrocarbons level to significantly reduce the operating cost. A pelletized ethylene/α-olefin copolymer product with delayed deformation enables operating the devolatilization process at a higher stripping agent inlet temperature at reduced holdup time with no major risk of blocking the devolatilization vessel in areas where pellets experience a high consolidation pressure.

The pelletized ethylene/α-olefin copolymer product described in this section may optionally include additives and adjuvants. Non-limiting examples of additives and adjuvants include, anti-blocking agents, antioxidants, heat stabilizers, slip agents, processing aids, anti-static additives, colorants, dyes, filler materials, light stabilizers, light absorbers, lubricants, pigments, plasticizers, nucleating agents and combinations thereof.

### Testing Methods

Prior to testing, each polymer specimen was conditioned for at least 24 hours at 23±2° C. and 50±10% relative humidity and subsequent testing was conducted at 23±2° C. and 50±10% relative humidity. Herein, the term “ASTM conditions” refers to a laboratory that is maintained at 23±2° C. and 50±10% relative humidity; and specimens to be tested were conditioned for at least 24 hours in this laboratory prior to testing. ASTM refers to the American Society for Testing and Materials.

### Density

Ethylene/α-olefin copolymer product densities were determined using ASTM D792-13 (Nov. 1, 2013).

### Melt Index

Ethylene/α-olefin copolymer product melt index was determined using ASTM D1238 (Aug. 1, 2013). Melt indexes, I₂ and I₂₁, were measured at 190° C., using a weight of 2.16 kg and 21.6 kg, respectively.

### Conventional Size Exclusion Chromatography (SEC) Ethylene/α-olefin copolymer product samples (polymer) solutions (1 to 3 mg/mL) were prepared by heating the polymer in 1,2,4-trichlorobenzene (TCB) and rotating on a wheel for 4 hours at 150° C. in an oven. An antioxidant, 2,6-di-tert-butyl-4-methylphenol (BHT), was added to the mixture in order to stabilize the polymer against oxidative degradation. The BHT concentration was 250 ppm. Polymer solutions were chromatographed at 140° C. on a PL 220 high-temperature chromatography unit equipped with four SHODEX® columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect GPC columns from oxidative degradation. The sample injection volume was 200 μL. The GPC columns were calibrated with narrow distribution polystyrene standards. The polystyrene molecular weights were converted to polyethylene molecular weights using the Mark-Houwink equation, as described in the ASTM standard test method D6474-12 (December 2012). The GPC raw data were processed with the Cirrus GPC software, to produce molar mass averages (Mₙ, M_{w}, M_{z}) and molar mass distribution (e.g., M_{w}/Mₙ and M_{z}/M_{w}). In the polyethylene art, a commonly used term that is equivalent to SEC is GPC, i.e., Gel Permeation Chromatography.

### Light Scattering Size Exclusion Chromatography (LS-SEC)

Ethylene/α-olefin copolymer product samples (polymer) solutions (1 to 3 mg/mL) were prepared by heating the polymer in 1,2,4-trichlorobenzene (TCB) and rotating on a wheel for 4 hours at 150° C. in an oven. An antioxidant, (2,6-di-tert-butyl-4-methylphenol (BHT), was added to the mixture in order to stabilize the polymer against oxidative degradation. The BHT concentration was 250 ppm. Sample solutions were chromatographed at 140° C. on a PL 220 high-temperature chromatography unit equipped with a dual-angle light scattering detector (15 and 90 degree). The SEC columns used were either four SHODEX columns (HT803, HT804, HT805 and HT806), or four PL Mixed ALS or BLS columns. TCB was the mobile phase with a flow rate of 1.0 mL/minute, BHT was added to the mobile phase at a concentration of 250 ppm to protect SEC columns from oxidative degradation. The sample injection volume was 200 μL. The SEC raw data were processed with the CIRRUS® GPC software, to produce absolute molar masses. The term “absolute”, M_{w}^{LS}, molar mass was used to distinguish LS-SEC determined absolute molar masses from the molar masses determined by conventional SEC.

### Fourier Transform Infrared (FTIR) Spectroscopy

The overall quantity of comonomer in the ethylene/α-olefin copolymer products was determined by FTIR and reported as the Short Chain Branching (SCB) content having dimensions of number of CH3 (methyl branches) per 1000 carbon atoms. This test was completed according to ASTM D6645-01 (2001), employing a compression molded polymer plaque and a Thermo-Nicolet 750 Magna-IR Spectrophotometer. The polymer plaque was prepared using a compression molding device (Wabash-Genesis Series press) according to ASTM D4703-16 (April 2016).

### Differential Scanning calorimetry (DSC)

First cooling thermograms were obtained for the ethylene/α-olefin copolymer product using differential scanning calorimetry (DSC) as follows: the instrument was first calibrated with indium; after the calibration, a specimen of the ethylene/α-olefin copolymer product was equilibrated at 0° C. and then the temperature was increased to 200° C. at a heating rate of 10 K/min; the melt was then kept isothermally at 200° C. for five minutes; and the melt was then cooled to 0° C. at a cooling rate of 10 K/min. The heat flow data obtained during the above-described first cooling cycle was then used to ascertain onset of crystallization (Tₒₙₛₑₜ), peak crystallization temperature (Tₘₐₓ) and the intermediate exothermic peak occurring between the onset of crystallization and the peak crystallization temperature.

### Linear Rheology in the Melt State

Oscillatory shear measurements under small strain amplitudes were carried out to obtain linear viscoelastic functions at 190° C. under N₂ atmosphere, at a strain amplitude of 10% and over a frequency range of 0.02-126 rad/s at 5 points per decade. Frequency sweep experiments were performed with a TA Instruments DHR3 stress-controlled rheometer using cone-plate (CP) geometry with a cone angle of 5°, a truncation of 137 μm and a diameter of 25 mm. In this experiment, a sinusoidal strain wave was applied, and the stress response was analyzed in terms of linear viscoelastic functions such as complex viscosity (|η*|) and complex modulus (|G*|).

The zero-shear rate viscosity (η₀) based on the obtained complex viscosity results was predicted by a 4-parameter Carreau-Yasuda model (see K. Yasuda (1979) PHD Thesis, IT Cambridge). The complex viscosity at a complex modulus of 10 kPa was interpolated (or extrapolated in case where the applied frequency range was not expansive to include a complex modulus of 10 kPa) using a fourth-order log-polynomial in according to |η*|=f(|G*|)=Σᵢ₌₀⁴aᵢ[log₁₀(|G*|)]ⁱ was fitted to the obtained |η*|−|G*| data.

It should be noted that in the case of samples with a high load melt index (I₂₁) of 15 dg/min or less, linear rheological tests were performed using a 25 mm parallel-plate (PP) geometry at a temperature of 190° C., a gap height of 1.5 mm at a strain amplitude of 10% and a frequency range of 0.2-126 rad/s at 5 point per decade. In cases where sample torque approached the high-torque limit of the instrument where a systematic error related to instrument compliance can corrupt the test data quality. Generally, at high frequencies, where sample stiffness approaches that of the rheometer, the deformation amplitude applied by the actuator is not fully transferred onto the sample [5]. This can lead to a smaller modulus being measured than the true value. In order to resolve this issue, a smaller geometry (i.e. a smaller diameter plate) or a smaller strain-amplitude can be applied.

### Rheological Softening Point

In order to determine the exact moment of softening (i.e., the point where elastic shear modulus started to drastically decay), the temperature-and frequency-dependence of the elastic shear modulus was simultaneously over a temperature range from 40° C. to 140° C. on pre-crystallized samples cooled from 140° C. to 40° C. at a cooling rate of 0.5 K/min.

In the present disclosure, the disclosed temperature sweeps were carried out using an Anton Paar MCR501 rotational rheometer equipped with a 25 mm parallel-plate (PP) geometry. A pre-compression molded disk of the ethylene/α-olefin copolymer product with a thickness of about 1.9-2 mm was loaded on the rheometer lower plate at a temperature close to 140° C. After reaching thermal equilibrium at 140° C., the upper plate was lowered squeezing the molten polymer at a rate of 1000 to 100 μm/s not exceeding a normal force of 40 N. The upper plate was lowered to a vertical position 30 μm above the testing gap-height and the excess molten sample was trimmed and the gap was lowered to the testing position of 1 mm. The temperature was then kept constant to reach thermal equilibrium at 140±0.1° C. The melt-state sample was then subjected to cooling to 40° C. at a cooling rate of −0.5 K/min under multi-wave oscillations and then heated to 140° C. at a heating rate of +0.5 K/min under multi-wave oscillations.

In these measurements, the strain-wave was prescribed as a superposition of multiple oscillation modes. The resulting stress-wave was then decomposed into sinusoidal components to compile stress amplitudes and phase-shifts corresponding to each strain-wave component. Linear viscoelastic functions were obtained by a multi-wave oscillation procedure enabling the measurement of viscoelastic functions (e.g., elastic shear modulus G′) simultaneously at several frequency levels, as a function of temperature, during both cooling and heating cycles. To achieve fast data recording, the fundamental frequency was set to 1 rad/s with its 2^{nd}, 4^{th}, 7^{th}, 10^{th}, 20^{th}, 40^{th}, 70^{th} harmonics. The multi-wave oscillation procedure consists of applying a decomposition procedure available in the rheometer software (RHEOPLUS/32 V3.40) to obtain the individual stress-wave for each frequency component from the resulting stress-wave. The duration of each scan was 60 s and a thermal ramp of ±0.5 K/min was applied during the crystallization and melting cycles. The resulting elastic shear modulus G′ at 1 rad/s was then numerically differentiated using backward differences to obtain the absolute value of the first-order log derivative function |dlogG′/dT| (in° C.⁻¹) which was then plotted as a function of temperature (T in ° C.) within a temperature range from 40° C. to 140° C. The obtained first-order log derivative function was further smoothened using a simple three-data point moving average method for further processing. The smoothened first-order log derivative function was then fitted within a temperature range from 50° C. to 130° C. with a sum of n+2 or n+3 Gaussian functions, where n is the number of peaks observed in the |dlogG′/dT| function (in ° C.⁻¹) when plotted as a function of temperature (T in ° C.) using EXCEL SOLVER. The fitted sum of n+2 or n+3 Gaussian functions was used to interpolate the moment of rheological softening point (RSP; i.e., the temperature at which |dlogG′/dT|=\sqrt{SₘᵢₙSₘₐₓ}, where Sₘᵢₙ is the absolute value of first-order log-derivative of elastic shear modulus at 50° C. and Sₘₐₓ is the maximum absolute value of first-order log-derivative of elastic shear modulus observed within a temperature range from greater than 50° C. to less than 110° C.) and to calculate the integrated area under the first-order log derivative function and the corresponding percent of crystalline fractions melted in each one of the temperature intervals of 50° C. to the RSP, RSP to RSP+40° C., and RSP+40° C. to RSP+70° C.

### Melt Strength

The melt strength is measured on Rosand RH-7 capillary rheometer (barrel diameter=15 mm) with a flat die of 2-mm Diameter, L/D ratio 10:1 at 190° C. Pressure Transducer: 10,000 psi (68.95 MPa). Piston Speed: 5.33 mm/min. Haul-off Angle: 52°. Haul-off incremental speed: 50-80 m/min2 or 65±15 m/min2. A polymer melt is extruded through a capillary die under a constant rate and then the polymer strand is drawn at an increasing haul-off speed until it ruptures. The maximum steady value of the force in the plateau region of a force versus time curve is defined as the melt strength for the polymer.

The following examples are presented for the purpose of illustrating selected embodiments of this disclosure; it being understood that the examples presented do not limit the claims presented.

### EXAMPLES

### Solution Polymerization Process

Solution polymerization process conditions for Examples 1 to 3 and Comparative Examples 1 and 3 are summarized in Tables 1a and 1b, respectively. These examples of ethylene/α-olefin copolymer products were made using a single site catalyst system in an “in-series” dual, continuously stirred tank reactor, “CSTR” reactor solution polymerization process. In this solution polymerization process, a first and second CSTR reactor are configured in series with one another and each reactor receives catalyst system component feeds. The dual CSTR reactor system is also followed by a downstream tubular reactor, also configured in series, which receives the exit stream of the second CSTR reactor, but to which additional catalyst system components are not fed. An “in series” “dual CSTR reactor”, solution phase polymerization process has been described in U.S. Pat. Appl. Pub. No. 2019/0135958.

Basically, in an “in-series” reactor system the exit stream from a first polymerization reactor (R1) flows directly into a second polymerization reactor (R2). The R1 pressure was from about 14 MPa to about 18 MPa; while R2 was operated at a lower pressure to facilitate continuous flow from R1 to R2. Both R1 and R2 were continuously stirred reactors (CSTR's). A third reactor, R3 was also used. The third reactor, R3 was a tubular reactor configured in series with the second reactor, R2 (i.e., the contents of reactor 2 flowed into reactor 3). The process was operated continuously by feeding fresh process solvent, ethylene, 1-octene and hydrogen to the at least the first and second reactors and in the removal of product. Methylpentane was used as the process solvent (a commercial blend of methylpentane isomers). The volume of the first CSTR reactor (R1) was 3.2 gallons (12 L), and the volume of the second CSTR reactor (R2) was 5.8 gallons (22 L). The volume of the tubular reactor (R3) was 0.58 gallons (2.2 L). Monomer (ethylene) and comonomer (1-octene) were purified prior to addition to the reactor using conventional feed preparation systems (such as contact with various absorption media to remove impurities such as water, oxygen and polar contaminants). The reactor feeds were pumped to the reactors at the ratios shown in Tables 1a and 1b. Average residence times for the reactors are calculated by dividing average flow rates by reactor volume and is primarily influenced by the amount of solvent flowing through each reactor and the total amount of solvent flowing through the solution process. For example, the average reactor residence times were: 61 seconds in R1, 73 seconds in R2, 7.3 seconds for an R3 volume of 0.58 gallons (2.2 L).

The following single site catalyst components were used to prepare the ethylene/α-olefin copolymer product in a first CSTR reactor (R1) configured in series to a second CSTR reactor (R2): diphenylmethylene (cyclopentadienyl) (2,7-di-t-butylfuorenyl)hafnium dimethide [(2,7-tBu₂Flu)Ph₂C(Cp)HfMe₂]; methylaluminoxane (MMAO-07); trityl tetrakis(pentafluoro-phenyl)borate (trityl borate), and 2,6-di-tert-butyl-4-ethylphenol (BHEB). Methylaluminoxane (MMAO-07) and 2,6-di-tert-butyl-4-ethylphenol are premixed in-line and then combined with diphenylmethylene(cyclopentadienyl)(2,7-di-t-butylfuorenyl)hafnium dimethide and trityl tetrakis(pentafluoro-phenyl) borate just before entering the polymerization reactor (e.g., R1 and R2). The efficiency of the single site catalyst formulation was optimized by adjusting the mole ratios of the catalyst components fed to R1 and R2 as well as the R1 and R2 catalyst components inlet temperature.

The total amount of ethylene supplied to the solution polymerization process can be portioned or split between the three reactors R1, R2 and R3. This operational variable is referred to as the Ethylene Split (ES), i.e., “ES^{R1}”, “ES^{R2}” and “ES^{R3}” refer to the weight percent of ethylene injected in R1, R2 and R3, respectively; with the proviso that ES^{R1}+ES^{R2}+ES^{R3}=100%. Similarly, the total amount of 1-octene supplied to the solution polymerization process can be portioned or split between the three reactors R1, R2 and R3. This operational variable is referred to as the Octene Split (OS), i.e., “OS^{R1}”, “OS^{R2}” and “OS^{R3}” refer to the weight percent of 1-octene injected in R1, R2 and R3, respectively; with the proviso that OS^{R1}+OS^{R2}+OS^{R3}=100%. The term “Q^{R1}” refers to the percent of the ethylene added to R1 that is converted into a copolymer by the catalyst formulation. Similarly, Q^{R2} and Q^{R3} represent the percent of the ethylene added to R2 and R3 that was converted into a copolymer, in the respective reactor. The term “QT” represents the total or overall ethylene conversion across the entire continuous solution polymerization plant—i.e., Q^{T}=100×[weight of ethylene in the ethylene/α-olefin copolymer product]/([weight of ethylene in the ethylene/α-olefin copolymer product]+[weight of unreacted ethylene]).

In Examples 1 and 3 and Comparative Example 1, ethylene was fed directly to the third reactor, R3, (i.e., the ethylene split, “ES^{R3}” was not zero to R3). This led to continued polymerization in the third reactor, due to the flow of active polymerization catalyst from second CSTR reactor, R2 to the third tubular reactor, R3. Alternatively, in the case of Example 2 and Comparative Example 3, no ethylene was fed directly to the third reactor, R3 (i.e., the ethylene split, “ES^{R}3-” to R3 was zero), leading to a non-significant extent of polymerization in the third reactor.

Polymerization in the continuous solution polymerization process was terminated by adding a catalyst deactivator to the third exit stream exiting the tubular reactor (R3). The catalyst deactivator used was octanoic acid (caprylic acid), commercially available from P&G Chemicals, Cincinnati, OH, U.S.A. The catalyst deactivator was added such that the moles of fatty acid added were 50% of the total molar amount of catalytic metal and aluminum added to the polymerization process; to be clear, the moles of octanoic acid added=0.5×(moles hafnium+moles aluminum).

A two-stage devolatilization process was employed to recover the ethylene/α-olefin copolymer product from the process solvent, i.e., two vapor/liquid separators were used, and the second bottom stream (from the second V/L separator) was passed through a gear pump/pelletizer combination. The gear pump was a VACOREX® 45/45 pump with 191 L/h capacity which was steam jacketed with 270#steam. The ethylene/α-olefin copolymer product leaving the gear pump was then passed through a 4″ diameter static mixer before entering the pelletizer where the ethylene/α-olefin copolymer product was forced through the holes in the die plate top down. There were 32 holes on the die with a hole diameter of 0.125″. the aspect ratio (i.e., length-to-diameter ratio) for each hole was 6.3:1 and the die had a thickness of 1.63″ and a diameter of 12″. There were 6 cutter knives—8.6878″ OD sweep and 6.2418 ID sweep—located on the side of the die that faced the cooling water system. There were internal heating channels within the die plate and die body and plate were heated with 600#or 270#steam. Cooling water system had a temperature range of from 10 to 80° C. and a flow of 7500-9500 kg/h.

DHT-4V (hydrotalcite), supplied by Kyowa Chemical Industry Co. LTD, Tokyo, Japan may be used as a passivator, or acid scavenger, in the continuous solution process. A slurry of DHT-4V in process solvent may be added prior to the first V/L separator.

Prior to pelletization, the ethylene/α-olefin copolymer product was stabilized by adding 500 ppm of Irganox 1076 (a primary antioxidant) and 500 ppm of IRGAFOS® 168 (a secondary antioxidant), based on weight of the ethylene/α-olefin copolymer product. Antioxidants were dissolved in process solvent and added between the first and second V/L separators.

Table 1a and 1b shows the reactor conditions used to make each of the inventive ethylene/α-olefin copolymer products (Examples 1 through 3) and Comparative Examples 1. Table 1a includes process parameters, such as the ethylene and 1-octene splits between the reactors (R1, R2 and R3), the reactor temperatures, the ethylene conversions, the amounts of hydrogen, ethylene and 1-octene concertation in the fresh feed to reactors, fresh feed total solution rates, CSTR reactors (R1 and R2) agitation speeds, etc.

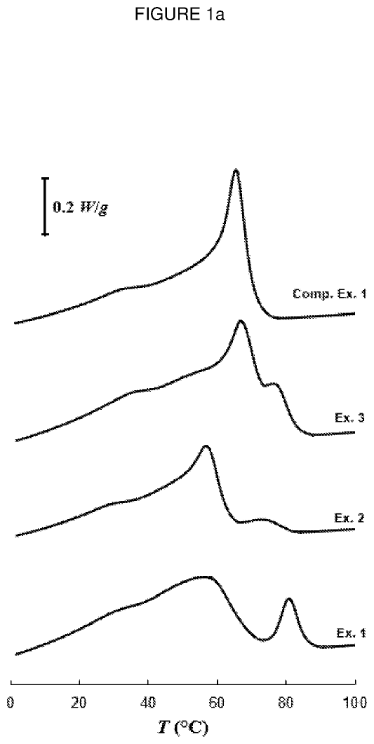

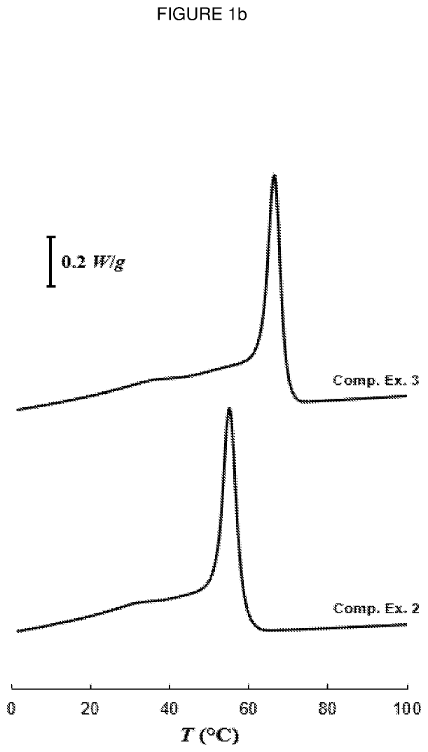

The DSC first cooling thermograms of the inventive ethylene/α-olefin copolymer products (Examples 1 through 3) as well as those for the comparative resins (Comparative Examples 1 through 3) are shown in FIGS. 1a and 1b. Comparative Example 2 was QUEO® 8201LA, a plastomeric ethylene/1-octene resin sold by Borealis AG. Comparative Example 3 was SUPREME™ 891 was a plastomeric ethylene/1-octene copolymer sold by SK Chemical. QUEO 8201LA has a density of about 0.881 g/cm³ and a melt index of about 1.1 g/10 min. SUPREME 891 has a density of about 0.885 g/cm³ and a melt index of about 1.0 g/10 min.

Comparative Example 1 was prepared under process conditions to produce an ethylene/α-olefin copolymer product with a Tₒₙₛₑₜ−Tₘₐₓ of no more than 20° C., wherein the peak crystallization temperature (Tₘₐₓ) is the exothermic peak with the maximum heat flow and the onset of crystallization (Tₒₙₛₑₜ) is the onset point where the heat producing DSC signal left the high-temperature baseline. Comparative Examples 1 had a target density of 0.885 g/cm³. Comparative Example 1 had an ES^{R3} and OS^{R3}=0.

With reference to FIG. 1a and TABLE 1a, it is understood that in the case of Example 2 with a target density of 0.880 g/cm³, where additional polymerizable monomers were not added directly to the third reactor (i.e., ES^{R3} and OS^{R3} were both zero), relative to the Comparative Example 1, a decreased rate of feeding to R2 (R2 total solution rate) led to an ethylene/α-olefin copolymer product having an onset of crystallization (Tₒₙₛₑₜ) at 83.9° C. and a peak crystallization temperature (Tₘₐₓ) at 56.8° C. during cooling from melt with a Tₒₙₛₑₜ−Tₘₐₓ of 27.1° C. A broad heat flow feature spanning between Tₒₙₛₑₜ and Tₘₐₓ with a peak at about 73° C. is also identifiable in the case of Example 2. Example 1 was prepared at a target density of 0.880 g/cm³ with a non-zero ES^{R3} and OS^{R3} at a decreased agitation speed in R2. Example 1 had an onset of crystallization (Tₒₙₛₑₜ) at 90.8° C. and a peak crystallization temperature (Tₘₐₓ) at 56.6° C. during cooling from melt with a Tₒₙₛₑₜ−Tₘₐₓ of 34.2° C. Example 3 was prepared at a target density of 0.885 g/cm³ with a non-zero ES^{R3} and OS^{R3} at a decreased agitation speed in R2. Example 3 had an onset of crystallization (Tₒₙₛₑₜ) at 87.6° C. and a peak crystallization temperature (Tₘₐₓ) at 67.0° C. during cooling from melt with a Tₒₙₛₑₜ−Tₘₐₓ of 20.6° C.

TABLE 1a
Continuous Solution Process Parameters for Ex. 1-3

| | Ex. 1 | Ex. 2 | Ex. 3 |
|---|---|---|---|
| R1 Catalyst (ppm)^{a} | 0.41 | 0.80 | 0.33 |
| R1 ([M^{b}]/[A]) Mole Ratio | 50 | 31 | 50 |
| R1 ([P^{c}]/[M]) Mole Ratio | 0.41 | 0.40 | 0.80 |
| R1 ([B^{d}]/[A]) Mole Ratio | 1.21 | 1.20 | 1.21 |
| R2 catalyst (ppm)^{a} | 0.42 | 0.27 | 0.39 |
| R2 ([M^{b}]/[A]) Mole Ratio | 55 | 31 | 55 |
| R2 ([P^{c}]/[M]) Mole Ratio | 0.40 | 0.40 | 0.40 |
| R2 ([B^{d}]/[A]) Mole Ratio | 1.20 | 1.21 | 1.20 |
| ES^{R1} (%) | 35.0 | 50 | 30.0 |
| ES^{R2} (%) | 45.0 | 50 | 50.0 |
| ES^{R3} (%) | 20.0 | 0 | 20.0 |
| R1 Ethylene Concentration in Fresh Feed (wt %) | 9.3 | 9.2 | 9.7 |
| R2 Ethylene Concentration in Fresh Feed (wt %) | 9.1 | 13.86 | 9.3 |
| R3 Ethylene Concentration in Fresh Feed (wt %) | 31.7 | — | 31.2 |
| 1-octene to Ethylene Ratio in R1 Fresh Feed | 0.993 | 0.738 | 1.074 |
| (wt. fraction) | | | |
| 1-octene to Ethylene Ratio in R2 Fresh Feed | 0.604 | 0.707 | 0.361 |
| (wt. fraction) | | | |
| 1-octene to Ethylene Ratio in R3 Fresh Feed | 0.771 | — | 1.074 |
| (wt. fraction) | | | |
| 1-octene to Ethylene Ratio (wt. fraction, total) | 0.710 | 0.649 | 0.661 |
| Polymer Production Rate (kg/h) | 42.3 | 48.8 | 40.7 |
| R1 Total Solution Rate (kg/h) | 152.0 | 270.3 | 122.7 |
| R2 Total Solution Rate (kg/h) | 207.4 | 179.7 | 223.1 |
| R3 Solution Rate (kg/h) | 33.2 | — | 29.8 |
| Total Solution Rate (kg/h)^{e} | 392.6 | 450.0 | 375.6 |
| OS^{R1} (%) | 45.0 | 51 | 45.0 |
| OS^{R2} (%) | 35.0 | 49 | 25.0 |
| OS^{R3} (%) | 20.0 | 0 | 30.0 |
| H₂ Concentration in R1 (ppm) | 2.06 | 1.50 | 7.37 |
| H₂ Concentration in R2 (ppm) | 1.02 | 1.00 | 1.01 |
| H₂ Concentration in R3 (ppm) | 1.02 | — | 0.52 |
| R1 Fresh Feed Inlet Temperature (° C.) | 30.0 | 30.0 | 30.0 |
| R2 Fresh Feed Inlet Temperature (° C.) | 30.0 | 30.0 | 30.0 |
| R3 Fresh Feed Inlet Temperature (° C.) | 129.9 | — | 130.0 |
| R1 Mean Temp (° C.) | 135.0 | 134.9 | 138.9 |
| R2 Mean Temp (° C.) | 153.0 | 167.0 | 150.9 |
| R3 Outlet Temperature (° C.) | 172.9 | 170.9 | 171.4 |
| Q^{R1} (%) | 75.0 | 80.1 | 75.0 |
| Q^{R2} (%) | 80 | 80.0 | 80 |
| Q^{R3} (%) | 70 | 25 | 75 |
| Q^{T} (%) | 90.78 | 91.00 | 92.13 |
| R1 Agitator Speed (rpm) | 325.0 | 690.0 | 325.0 |
| R2 Agitator Speed (rpm) | 260.0 | 690.0 | 260.0 |

^{a}[(2,7-tBu₂Flu)Ph₂C(Cp)HfMe₂]
^{b}methylaluminoxane (MMAO-7)
^{c}2,6-di-tert-butyl-4-ethylphenol
^{d}trityl tetrakis(pentafluoro-phenyl)borate
^{e}Total solution rate in kg/h = R1 total solution rate in kg/h + R2 total solution rate in kg/h + R3 total solution rate in kg/h

TABLE 1b
Continuous Solution Process Parameters for Comp. Ex. 1 and 3

| | Comp. Ex. 1 |
|---|---|
| R1 catalyst (ppm)^{a} | 0.77 |
| R1 ([M^{b}]/[A]) Mole Ratio | 50 |
| R1 ([P^{c}]/[M]) Mole Ratio | 0.40 |
| R1 ([B^{d}]/[A]) Mole Ratio | 1.20 |
| R2 catalyst (ppm)^{a} | 0.46 |
| R2 ([M^{b}]/[A]) Mole Ratio | 55 |
| R2 ([P^{c}]/[M]) Mole Ratio | 0.40 |
| R2 ([B^{d}]/[A]) Mole Ratio | 1.20 |
| ES^{R1} (%) | 50 |
| ES^{R2} (%) | 50 |
| ES^{R3} (%) | 0 |
| R1 Ethylene Concentration in Fresh Feed (wt %) | 8.6 |
| R2 Ethylene Concentration in Fresh Feed (wt %) | 14.2 |
| R3 Ethylene Concentration in Fresh Feed (wt %) | — |
| 1-octene to Ethylene Ratio in R1 Fresh Feed (wt. fraction) | 0.659 |
| 1-octene to Ethylene Ratio in R2 Fresh Feed (wt. fraction) | 0.653 |
| 1-octene to Ethylene Ratio in R3 Fresh Feed (wt. fraction) | — |
| 1-octene to Ethylene Ratio (wt. fraction, total) | 0.593 |
| Polymer Production Rate (kg/h) | 57.7 |
| R1 Total Solution Rate (kg/h) | 341.9 |
| R2 Total Solution Rate (kg/h) | 207.7 |
| R3 Solution Rate (kg/h) | — |
| Total Solution Rate (kg/h)^{e} | 549.6 |
| OS^{R1} (%) | 50 |
| OS^{R2} (%) | 50 |
| OS^{R3} (%) | 0 |
| H₂ Concentration in R1 (ppm) | 1.80 |
| H₂ Concentration in R2 (ppm) | 2.00 |
| H₂ Concentration in R3 (ppm) | — |
| R1 Feed Inlet Temperature (° C.) | 45.0 |
| R2 Feed Inlet Temperature (° C.) | 30.0 |
| R3 Feed Inlet Temperature (° C.) | 130.0 |
| R1 Mean Temp (° C.) | 136.1 |
| R2 Mean Temp (° C.) | 174.7 |
| R3 Outlet Temperature (° C.) | 175.9 |
| Q^{R1} (%) | 79.9 |
| Q^{R2} (%) | 81.1 |
| Q^{R3} (%) | 25 |
| Q^{T} (%) | 91 |
| R1 Agitator Speed (rpm) | 900.0 |
| R2 Agitator Speed (rpm) | 690.0 |

^{a}[(2,7-tBu₂Flu)Ph₂C(Cp)HfMe₂]
^{b}methylaluminoxane (MMAO-7)
^{c}2,6-di-tert-butyl-4-ethylphenol
^{d}trityl tetrakis(pentafluoro-phenyl)borate
^{e}Total solution rate in kg/h = R1 total solution rate in kg/h + R2 total solution rate in kg/h + R3 total solution rate in kg/h

The M_{w}, Mₙ, M_{w}/Mₙ, weight percent, branching frequency (i.e., the BrF=the SCB per 1000 carbons in the polymer backbone) of each component made in R1, R2 and R3 and R2 and R3 feed zones were calculated and shown in Tables 2a and 2b using a reactor model simulation using the input conditions which were employed for actual pilot scale run conditions. For references on relevant reactor modeling methods, see “Copolymerization” by A. Hamielec, J. MacGregor, and A. Penlidis in Comprehensive Polymer Science and Supplements, volume 3, Chapter 2, page 17, Elsevier, 1996 and “Copolymerization of Olefins in a Series of Continuous Stirred-Tank Slurry-Reactors using Heterogeneous Ziegler-Natta and Metallocene Catalysts. I. General Dynamic Mathematical Model” by J. B. P Soares and A. E Hamielec in Polymer Reaction Engineering, 4(2&3), p153, 1996.

The model takes for input the flow of several reactive species (e.g., catalyst, monomer such as ethylene, comonomer such as 1-octene, hydrogen, and solvent) going to each reactor, the temperature (in each reactor), and the conversion of monomer (in each reactor) and calculates the polymer properties (of the polymer made in each reaction zone) using a terminal kinetic model for continuously stirred tank reactors (CSTRs) connected in series. The “terminal kinetic model” assumes that the kinetics depend upon the monomer unit within the polymer chain on which the active catalyst site is located (see “Copolymerization” by A. Hamielec, J. MacGregor, and A. Penlidis in Comprehensive Polymer Science and Supplements, Volume 3, Chapter 2, page 17, Elsevier, 1996). In the model, the copolymer chains are assumed to be of reasonably large molecular weight to ensure that the statistics of monomer/comonomer unit insertion at the active catalyst center is valid and that monomers/comonomers consumed in routes other than propagation are negligible. This is known as the “long chain” approximation.

The terminal kinetic model for polymerization includes reaction rate equations for activation, initiation, propagation, chain transfer, and deactivation pathways. This model solves the steady-state conservation equations (e.g., the total mass balance and heat balance) for the reactive fluid which comprises the reactive species identified above. The total mass balance for a generic CSTR with a given number of inlets and outlets is given by:

$$0 = {\sum }_{i} {\dot{m}}_{i} \qquad ( eq . 5 )$$

where \dot{m}ᵢ represents the mass flow rate of individual streams with index i indicating the inlet and outlet streams. Equation 5 can be further expanded to show the individual species and reactions:

$$0 = \frac{{\sum }_{i} m \dot{{x}_{{ι}_{J}}} / {M}_{i}}{{ρ}_{m i x} V} + {R}_{j} / {ρ}_{m i x} \qquad ( eq . 5 )$$

where Mᵢ is the average molar weight of the fluid inlet or outlet i, xᵢⱼ is the mass fraction of species j in stream i, ρₘᵢₓ is the molar density of the reactor mixture, V is the reactor volume, Rⱼ is the reaction rate for species j, which has units of kmol/m³s. The total heat balance is solved for an adiabatic reactor and is given by:

$$0 = ( \sum {\dot{m}}_{i} Δ {H}_{i} + {q}_{R x} V + \dot{W} - \dot{Q} ) \qquad ( eq . 6 )$$

where, \dot{m}ᵢ is the mass flow rate of stream i (inlet or outlet), ΔHᵢ is the difference in enthalpy of stream i versus a reference state, q_{Rx} is the heat released by reaction(s), V is the reactor volume, \dot{W} is the work input (i.e., agitator), \dot{Q} is the heat input/loss. The catalyst concentration input to each reactor is adjusted to match the experimentally determined ethylene conversion and reactor temperature values in order solve the equations of the kinetic model (e.g., propagation rates, heat balance and mass balance). The H₂ concentration input to each reactor may be likewise adjusted so that the calculated molecular weight distribution of a polymer made over all reactors (and, hence, the molecular weight of polymer made in each reactor) matches that which is observed experimentally.

The weight percent of material made in each reaction zone (i.e., overall R1, R2 in, and R3 and feed zones of R2 and R3 as tabulated in Tables 2a and 2b) is determined based on the mass flow of monomer and comonomer into each reactor together with the monomer and comonomer conversions in each reactor calculated based on kinetic reactions. Feed zone of each reactor has been modeled as a standalone CSTR reactor following the same overall reaction kinetics. However, the concertation of monomers in the feed zones of reactors is higher than that of the bulk of their respective reactor. The concertation of monomers is calculated based on a mass balance including feed flowrate and concertation as well as material exchange with bulk of the reactor. In which the former is priory known and the latter is calculated based on the hydraulic model developed based on the reactor size, agitator speed and physical properties of the solution in the feed zone. Reported weight percent values shown in Tables 2a and 2b are such that the sum of the weight percent of the material made in R1, R2 and R3 (i.e., R1, overall R2 and overall R3) is at 100 percent and weight percent of the fractions made in R2 and R3 feed zones are reported as a percent of the total weight of produced ethylene/α-olefin copolymer product in the entire system (i.e., R1 overall plus R2 overall plus R3 overall).

The degree of polymerization (dpn) for a polymerization reaction is given by the ratio of the rate of chain propagation reactions over the rate of chain transfer/termination reactions:

$$d {p}_{n} = \frac{{k}_{p 11} {ϕ}_{1} [ {m}_{1} ] + {k}_{p 12} {ϕ}_{1} [ {m}_{2} ] + {k}_{p 21} {ϕ}_{2} [ {m}_{2} ]}{{k}_{tm 11} [ {m}_{1} ] {ϕ}_{1} + {k}_{tm 12} [ {m}_{2} ] {ϕ}_{1} + {k}_{tm 21} [ {m}_{2} ] {ϕ}_{2} + {k}_{ts 1} {ϕ}_{1} + {k}_{ts 2} {ϕ}_{2} + {k}_{tH 1} [ H ] + {k}_{tH 2} [ H ]} = \frac{{R}_{p}}{{R}_{t}} \qquad ( eq . 7 )$$

where kₚ₁₂ is the propagation rate constant for adding monomer 2 (1-octene) to a growing polymer chain ending with monomer 1 (ethylene), [m₁] is the molar concentration of monomer 1 in the reactor, [m₂] is the molar concentration of monomer 2 in the reactor, kₜₘ₁₂ the termination rate constant for chain transfer to monomer 2 for a growing chain ending with monomer 1, kₜₛ₁ is rate constant for the spontaneous chain termination for a chain ending with monomer 1, k_{tH1} is the rate constant for the chain termination by hydrogen for a chain ending with monomer 1. ϕ₁ and ϕ₂ and the fraction of catalyst sites occupied by a chain ending with monomer 1 or monomer 2 respectively.

The number average molecular weight (Mn) for a polymer follows from the degree of polymerization and the molecular weight of a monomer unit. From the number average molecular weight of polymer in a given reactor, and assuming a Flory-Schulz distribution for a single site catalyst, the molecular weight distribution is determined for the polymer using the following relationships.

$$w ( n ) = n {τ}^{2} {e}^{- τ n} \qquad ( eq . 8 )$$

where n is the number of monomer units in a polymer chain, w(n) is the weight fraction of polymer chains having a chain length n, and τ is calculated using the equation below:

$$τ = \frac{1}{d {p}_{n}} = \frac{{R}_{t}}{{R}_{p}} \qquad ( eq . 9 )$$

where dpₙ is the degree of polymerization, Rₚ is the rate of propagation and Rₜ is the rate of termination. The Flory-Schulz distribution can be transformed into the common log scaled gel permeation chromatography, GPC trace by applying:

$$\frac{d W}{d log ( M )} = ln ( 10 ) \frac{{n}^{2}}{d {p}_{n} 2} {e}^{( - \frac{n}{d {p}_{n}} )} \qquad ( eq . 10 )$$

where

$$\frac{dW}{d log ( MW )}$$

is the differential weight fraction of polymer with a chain length n (n=MW/28 where 28 is the molecular weight of the polymer segment corresponding to a C₂H₄ unit) and dpₙ is the degree of polymerization.

Assuming a Flory-Schultz model, different moments of molecular weight distribution can be calculated using the following:

$${μ}_{i} = {\int }_{0}^{∞} {n}^{i} W ( n ) dn \qquad ( eq . 11 )$$

thus, μ₀=1, μ₁=dpₙ, and μ₂=2dpₙ²; so:

$$\begin{matrix}{M}_{n} = M {w}_{monomer} \frac{{μ}_{1}}{{μ}_{0}} = {Mw}_{m onomer} d {p}_{n} \\ {M}_{w} = M {w}_{monomer} \frac{{μ}_{2}}{{μ}_{1}} = 2 {Mw}_{m onomer} d {p}_{n}\end{matrix} \qquad ( eq . 12 )$$

where Mwₘₒₙₒₘₑᵣ is the molecular weight of the polymer segment corresponding to a C₂H₄ unit of monomer. Finally, when a single site catalyst produces long chain branching, the molecular weight distribution is determined for the polymer using the following relationships (see “Polyolefins with Long Chain Branches Made with Single-Site Coordination Catalysts: A Review of Mathematical Modeling Techniques for Polymer Microstructure” by J. B. P Soares in Macromolecular Materials and Engineering, volume 289, Issue 1, Pages 70-87, Wiley-VCH, 2004 and “Polyolefin Reaction Engineering” by J. B. P Soares and T. F. L. McKenna Wiley-VCH, 2012).

$$w ( n ) = \frac{( 1 - α ) {τ}_{B} {e}^{- {τ}_{B} n}}{( 1 + α )} {I}_{1} ( 2 \frac{{τ}_{B} n \sqrt{α}}{1 + α} ) \qquad ( eq . 13 )$$

where n is the number of monomer units in a polymer chain, w(n) is the weight fraction of polymer chains having a chain length n, and τ_{B} and α are calculated using equations below:

$$\begin{matrix}{τ}_{B} = \frac{1}{d {p}_{n}^{B}} = \frac{{R}_{t} + {R}_{L C B}}{{R}_{p}} \\ α = \frac{{R}_{L C B}}{{R}_{p}}\end{matrix} \qquad ( eq . 14 )$$

where dpₙ^{B} is degree of polymerization, Rₚ is the rate propagation, Rₜ is the rate of termination and R_{LCB} is the rate of long chain branching formation calculated using equation below:

$${R}_{L C B} = {k}_{p 13} {ϕ}_{1} [ {m}_{3} ] \qquad ( eq . 15 )$$

where kₚ₁₃ is the propagation rate constant for adding monomer 3 (macromonomer which formed in the reactor) to a growing polymer chain ending with monomer 1, [m₃] is the molar concentration of macromonomer in the reactor. The weight distribution can be transformed into the common log scaled GPC trace by applying:

$$\frac{dW}{d log ( M )} = ln ( 10 ) \frac{( 1 - α ) {τ}_{B} {e}^{- {τ}_{B} n}}{( 1 + α ) \sqrt{α}} {I}_{1} ( 2 \frac{{τ}_{B} n \sqrt{α}}{1 + α} ) \qquad ( eq . 16 )$$

where

$$\frac{dW}{d log ( MW )}$$

is the differential weight fraction of polymer with a chain length n (n=MW/28 where 28 is the molecular weight of the polymer segment corresponding to a C₂H₄ unit). From the weight distribution, different moments of molecular weight distribution can be calculated using the following:

$${M}_{n} = {Mw}_{monomer} {dp}_{n}^{B} \frac{1 + α}{1 - α} \qquad ( eq . 17 )$$

$${M}_{w} = 2 {Mw}_{monomer} {dp}_{n}^{B} \frac{1 + α}{{( 1 - α )}^{2}}$$

where dpₙ^{B} is degree of polymerization, and a is calculated as explained.

Assuming that addition of monomer 2 (1-octene) unit to a chain ending in an octene terminal unit is insignificant, the number of octene after ethylene steps will be equivalent to the number of ethylene after octene steps. The branch content of the resultant polymer per thousand backbone carbon atoms (500 monomer units), BrF will be the ratio of the rate of addition of monomer 1 (ethylene) to the rate of the addition of monomer 2 (1-octene).

$$( eq . 18 )$$

$$BrF = \frac{rate of addition of monomer 2 after monomer 1}{rate of addition of monomer 1 after monomer 1} \times 500 = \frac{[ {m}_{2} ] {k}_{p 12}}{[ {m}_{1} ] {k}_{p 11}} \times 500$$

where kₚ₁₂ is the propagation rate constant for adding monomer 2 (1-octene) to a growing polymer chain ending with monomer 1 (ethylene), kₚ₁₁ is the propagation rate constant for adding monomer 1 (ethylene) to a growing polymer chain ending with monomer 1, [m₁] is the molar concentration of monomer 1 in the reactor, and [m₂] is the molar concentration of monomer 2 in the reactor.

TABLE 2a
Deconvolution of Ethylene/α-olefin Copolymer Products of Examples
1-3 into Components Made in R1, R2, R3 and Feed Zones of R2 and R3

| | | | | R2 | | R3 |
|---|---|---|---|---|---|---|
| | | R1 | R2 | (feed | R3 | (feed |
| | | (overall) | (overall) | zone) | (overall) | zone) |
| Example | Weight Percent (%) | 29.5 | 47.9 | 1.8 | 22.6 | 0.4 |
| 1 | Mₙ (g/mol) | 97574 | 36396 | 139023 | 24931 | 57146 |
| | M_{w} (g/mol) | 202297 | 81893 | 295392 | 75872 | 116755 |
| | Polydispersity (M_{w}/Mₙ) | 2.07 | 2.25 | 2.12 | 3.04 | 2.04 |
| | SCB per 10³ Carbons | 45.1 | 48.7 | 31.0 | 39.8 | 29.1 |
| Example | Weight Percent (%) | 45.3 | 54.7 | 0.6 | — | — |
| 2 | Mₙ (g/mol) | 82340 | 22990 | 120695 | — | — |
| | M_{w} (g/mol) | 172794 | 49440 | 256720 | — | — |
| | Polydispersity (M_{w}/Mₙ) | 2.10 | 2.15 | 2.13 | — | — |
| | SCB per 10³ Carbons | 40.9 | 46.5 | 26.0 | — | — |
| Example | Weight Percent (%) | 27.4 | 51.3 | 1.7 | 21.3 | 0.5 |
| 3 | Mₙ (g/mol) | 65230 | 38269 | 137165 | 29169 | 60848 |
| | M_{w} (g/mol) | 135449 | 85059 | 292713 | 79835 | 124731 |
| | Polydispersity (M_{w}/Mₙ) | 2.08 | 2.22 | 2.13 | 2.74 | 2.05 |
| | SCB per 10³ Carbons | 45.4 | 40.5 | 25.2 | 37.0 | 28.4 |

TABLE 2b
Deconvolution of Ethylene/α-olefin Copolymer Product of Comparative
Examples 1 into Components Made in R1 and R2 and the Feed Zone of R2

| | | | | R2 | | R3 |
|---|---|---|---|---|---|---|
| | | R1 | R2 | (feed | R3 | (feed |
| | | (overall) | (overall) | zone) | (overall) | zone) |
| Comp. | Weight Percent (%) | 44.5 | 55.5 | 0.6 | — | — |
| Example | Mₙ (g/mol) | 81688 | 18045 | 104053 | — | — |
| 3 | M_{w} (g/mol) | 171375 | 39092 | 219786 | — | — |
| | Polydispersity (M_{w}/Mₙ) | 2.10 | 2.17 | 2.11 | — | — |
| | SCB per 10³ Carbons | 37.5 | 43.0 | 22.0 | — | — |

TABLE 3
Physical, Molecular, Thermal and Melt Rheological Characteristics
of Examples 1-3 and Comparative Examples 1-4

| | Ex. 1 | Ex. 2 | Ex. 3 |
|---|---|---|---|
| Density (g/cm³) | 0.88 | 0.88 | 0.884 |
| Melt Index MI₂ (g/10 min) | 0.49 | 0.89 | 0.92 |
| Melt Index MI₆ (g/10 min) | 3.27 | 4.97 | 4.73 |
| Melt Index MI₂₁ (g/10 min) | 25.9 | 50.1 | 37.3 |
| Melt Flow Ratio (MI₂₁/MI₂) | 54 | 56.6 | 40.8 |
| Stress Exponent (—) | 1.75 | 1.57 | 1.49 |
| Onset of Crystallization (° C.) | 90.8 | 83.9 | 87.6 |
| Tmax (° C.) | 56.6 | 56.8 | 67 |
| Comonomer Content (mol %) | 8.7 | 9 | 8.1 |
| Comonomer Type | 1-octene | 1-octene | 1-octene |
| SCB per 10³ Carbons | 43.5 | 45.2 | 40.3 |
| Mₙ (g/mol) | 43566 | 30345 | 44588 |
| M_{w} (g/mol) | 118404 | 98007 | 101923 |
| M_{z} (g/mol) | 260058 | 225640 | 227647 |
| M_{w}/Mₙ (—) | 2.72 | 3.23 | 2.29 |
| Zero-Shear Viscosity (kPa · s) | 80.8 | 36.4 | 23.9 |
| Melt Strength (cN) | 6.5 | 4.4 | 4 |

TABLE 3
Physical, Molecular, Thermal and Melt Rheological Characteristics
of Examples 1-3 and Comparative Examples 1-4 - CONTINUED

| | Comp. Ex. | Comp. Ex. | Comp. Ex. | Comp. Ex. |
|---|---|---|---|---|
| | 1 | 2 | 3 | 4 |
| Density (g/cm³) | 0.885 | 0.8812 | 0.8854 | 0.8657 |
| Melt Index MI₂ (g/10 min) | 1.21 | 1.16 | 0.99 | 0.57 |
| Melt Index MI₆ (g/10 min) | 6.78 | 5.54 | 4.22 | 2.84 |
| Melt Index MI₂₁ (g/10 min) | 74 | 39.5 | 28.1 | 20.3 |
| Melt Flow Ratio (MI₂₁/MI₂) | 61 | 34 | 28.6 | 35.6 |
| Stress Exponent (—) | 1.57 | 1.42 | 1.32 | 1.46 |
| Onset of Crystallization (° C.) | 78.2 | 64.6 | 73.8 | 74.5 |
| Tmax (° C.) | 65.5 | 54.7 | 66.4 | 66.5 |
| Comonomer Content (mol %) | 8.2 | 8.4 | 8 | 10.8 |
| Comonomer Type | 1-octene | 1-octene | 1-octene | 1-octene |
| SCB per 10³ Carbons | 41.0 | 42.0 | 40.1 | 54.0 |
| Mₙ (g/mol) | 25190 | 46272 | 41873 | 54875 |
| M_{w} (g/mol) | 89116 | 91528 | 92188 | 113660 |
| M_{z} (g/mol) | 216981 | 150898 | 156224 | 190307 |
| M_{w}/Mₙ (—) | 3.54 | 1.98 | 2.2 | 2.07 |
| Zero-Shear Viscosity (kPa · s) | 23.6 | 28.9 | 16 | 56.4 |
| Melt Strength (cN) | 3.6 | 3.44 | 3.53 | 5.71 |

By combining the data shown in Tables 2a and 2b with those shown in Table 3, one could observe that Example 1 through 3 comprise a first high-density fraction with a ΔSCB₁ of less than −10 branch point per 1000 carbons and a M_{w,1}^{HD}/M_{w}>2. To be specific, Example 1 included 1.8 weight percent of a fraction made in the feed zone of R2 having a ΔSCB₁=31.0−43.5=−12.5 <−10 SCB per 10³ carbons and a M_{w,1}^{HD}/M_{w}=295392/118404≈2.5. Example 2 included 0.6 weight percent of a fraction made in the feed zone of R2 having a ΔSCB₁=26.0−45.2=−19.2<−10 SCB per 10³ carbons and a M_{w,1}^{HD}/M_{w}=256720/98007≈2.6. Example 3 included 1.7 weight percent of a first high-density fraction made in the feed zone of R2 having a ΔSCB₁=25.2−40.3=−15.1<−10 SCB per 10³ carbons and a M_{w,1}^{HD}/M_{w}=292713/101923≈2.9. Examples 1-3 had a weight-average molecular weight M_{w} of from 95 to 140 kg/mol and a z-average molecular weight M_{z} of 220 to 280 kg/mol.

It was further noticeable that the Comparative Example 1 included 0.6 weight percent of a first high-density fraction made in the feed zone of R2 having a ΔSCB₁=22.0−41.0=−19.0<−10 SCB per 10³ carbons and a M_{w,1}^{HD}/M_{w}=219786/89116≈2.5. Comparative Example 1 had an M_{w} less than 95 kg/mol and an M_{z} outside the range 220 to 280 kg/mol.

Examples 1 and 3 further comprise a high-density fraction characterized as having a short chain branching content (SCB₂^{HD}) distinct from and less than the overall short chain branching content (SCB) of the ethylene/α-olefin copolymer product; and a weight-average molecular weight M_{w,2}^{HD} indistinct from that of the ethylene/α-olefin copolymer product. To be specific, Examples 1 and 3 comprise a second high-density fraction made in the feed zone of R3 characterized as having ΔSCB₂ of −14.4 and −15.1 SCB per 10³ carbons, and a M_{w,2}^{HD}/M_{w} of 1.0 and 1.1, respectively.

The process conditions of the continuous solution polymerization process described in Examples 1-3 could be designed to decrease or increase the weight percent, short chain branching content and molecular weight of the first and second high-density fractions which were made in R2 and R3 feed zones compared to the ethylene/α-olefin copolymer product.

In the bigger volume CSTR reactor (R2), a portion of the reactor volume proximal the monomers feed nozzle experiences a higher concentration of polymerizable monomers than the bulk of the reactor. Accordingly, a first high-density fraction is made in said “feed zone” off R2 with a short chain branching content and molecular weight that are distinct from those of the overall product made in this reactor. The weight percent of the first high-density fraction made in R2 feed zone is directly proportional to the size of the feed zone. In addition to the size of the feed zone, temperature, and concentration of the polymerizable monomers (ethylene and 1-octene) in the feed zone could impact the nature of the polymer made in the feed zone. Assuming a constant reactor volume, impeller speed and polymerizable monomers concentrations in the fresh feed, a higher feed rate (i.e., R2's TSR) can increase the size of the feed zone and can consequently increase the weight percent of the first high-density fraction made in R2 feed zone. The size of the feed zone in R2 could be increased more effectively via reducing the agitation speed in the second reactor. By increasing the ethylene concentration in the fresh feed (e.g., by injecting a portion of 1-octene and process solvent from another feed nozzle), one could further achieve a lower short chain branching content for the first high-density fraction made in R2 feed zone. Given the strong temperature sensitivity of polymerization kinetics, the molecular weight and short chain branching content of the first high-density fraction could also be modified by adjusting the fresh monomers feed temperature.

Similarly, in the case of the tubular reactor R3, the molecular characteristics of the second high-density fraction made in the reactor feed zone could be modified through adjusting ethylene and 1-octene concentrations in the fresh feed, fresh feed temperature, R3 TSR, etc.

The pilot scale Examples described in this section contain long-chain branched structures characterized according to a zero-shear viscosity (η₀) at 190° C. which satisfies the inequality of

$$log [ {{η}_{0} ( \frac{{M}_{z}}{{M}_{w}} )}^{0.4} ] - log ( {η}_{0}^{lin} ) > 0.156 .$$

As an instance, with reference to Table 3, Example 1 had a zero-shear viscosity at 190° C. of 80.8 kPa·s, an n_{c} of 0.087 and an M_{z}/M_{w} of 2.2. This ethylene/1-octene copolymer product had an m_{b}=[n_{c}M_{w}^{como}+28(1−n_{c})]/2=17.7 g/mol with a M_{w}^{como} of 112.24 for 1-octene. This Example had an absolute molecular weight of M_{w}^{LS} of 136.0 kg/mol (not shown in Table 4). Thus, this Example had a

$$log [ {{η}_{0} ( \frac{{M}_{z}}{{M}_{w}} )}^{0.4} ] - log ( {η}_{0}^{lin} ) of 0.893 .$$

As another instance, Example 3 with a zero-shear viscosity at 190° C. of 23.9 kPa·s, an n_{c} of 0.081 (or an m_{b} of 17.3 g/mol), an M_{z}/M_{w} of 2.2, an M_{w}^{LS} of 110.0 kg/mol (not shown in Table 3) had a

$$log [ {{η}_{0} ( \frac{{M}_{z}}{{M}_{w}} )}^{0.4} ] - log ( {η}_{0}^{lin} ) of 0.678 .$$

Similarly, Example 2 with a zero-shear viscosity at 190° C. of 36.4 kPa·s, an n_{c} of 0.09 (or an m_{b} of 17.8), an M_{z}/M_{w} of 2.3, an M_{w}^{LS} of 117.0 kg/mol (not shown in Table 3) had a

$$log [ {{η}_{0} ( \frac{{M}_{z}}{{M}_{w}} )}^{0.4} ] - log ( {η}_{0}^{lin} ) of 0.79 .$$

Table 4 compares the percent of fractions melted in each one of the temperature intervals of from 50° C. to RSP, from RSP to RSP+40° C. and from RSP+40° C. to RSP to 70° C. As previously described in the DETAILED DESCRIPTION section, the percent of fractions melted in each one of the above-described temperature intervals are determined by integrating the sum of the fitted Gaussian functions within each temperature interval.

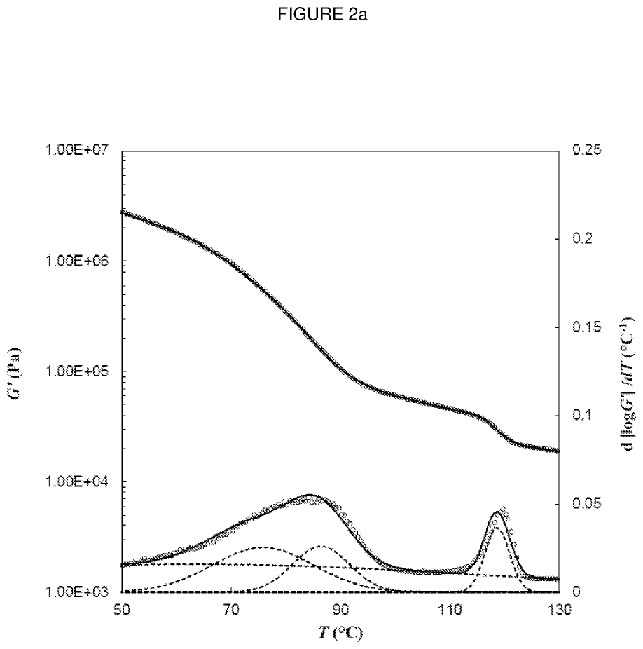

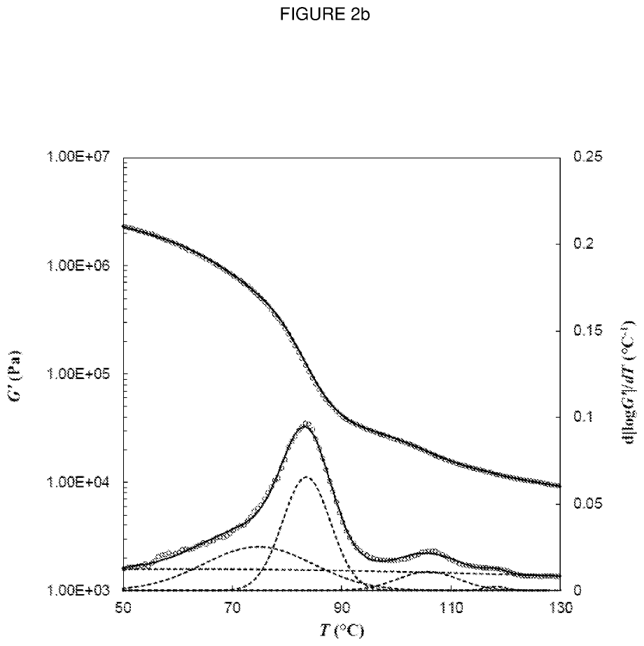

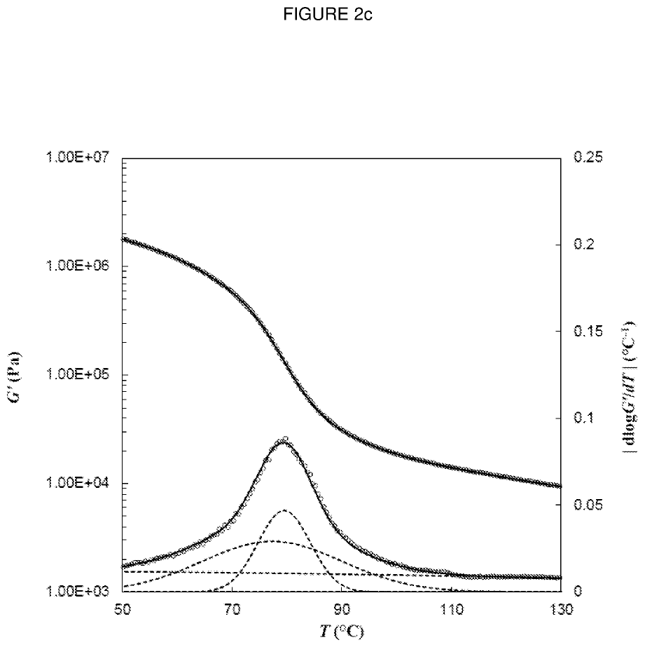

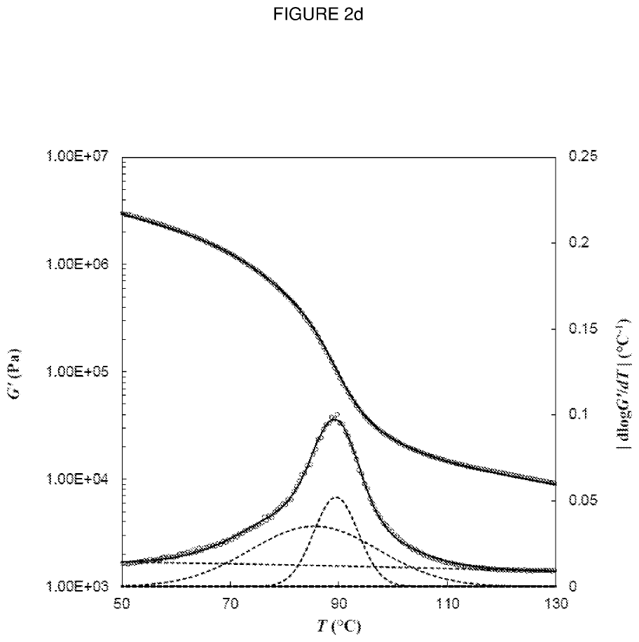

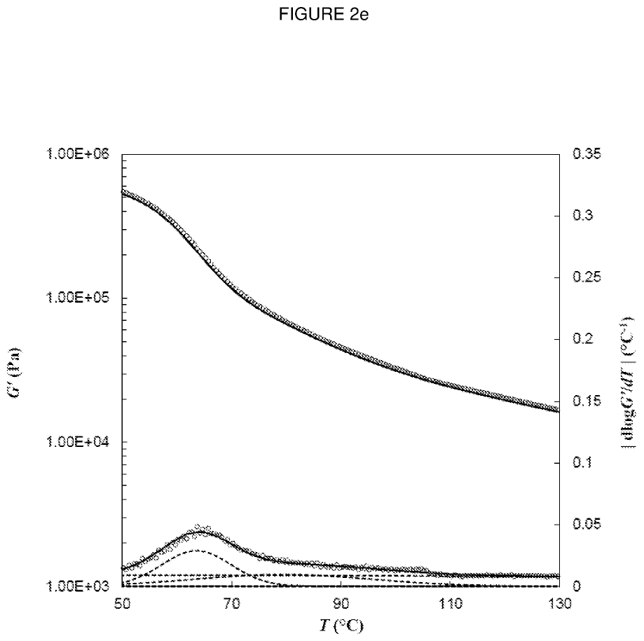

The first-order log-derivative of elastic shear modulus data (|dlogG′/dT| in ° C.⁻¹) for Example 1 (see FIG. 2a) was fitted with a sum of 4 (or n+2 where n is the number of peaks observed in the |dlogG′/dT| function when plotted as a function of temperature) Gaussian functions within the temperature range from 50° C. to 130° C. The fitted sum of Gaussian functions had a first term with a G₁=2.14, a δ₁^{T}=54.7, a T₁⁰=62.9° C.; a second term with a G₂=0.59, a δ₂^{T}=9.2, a T₂⁰=75.8° C.; a third term with a G₃=0.34, a δ₃^{T}=5.2, a T₃⁰=86.4° C.; and a fourth term with a G₄=0.21, a δ₄^{T}=2.3, a T₄⁰=118.6° C. The first Gaussian term that describes the nearly temperature-independent slope behavior within the pre-softening and post-melting regions was excluded in determination of the crystalline fractions melted within each one of the temperature intervals.

The first-order log-derivative of elastic shear modulus data (|dlogG′/dT| in ° C.⁻¹) for Comparative Example 1 (see FIG. 2b) was fitted with a sum of 5 (or n+3 where n is the number of peaks observed in the |dlogG′/dT| function when plotted as a function of temperature) Gaussian functions. The fitted sum of Gaussian functions had a first term with a G₁=2.50, a δ₁^{T}=81.4, a T₁⁰=59.5° C.; a second term with a G₂=0.63, a δ₂^{T}=10.0, a T₂⁰=74.8° C.; a third term with a G₃=0.72, a δ₃^{T}=4.4, a T₃⁰=83.6° C.; a fourth term with a G₄=0.15, a δ₄^{T}=5.6, a T₄⁰=105.8° C.; and a fifth term with a G₅=0.01, a δ₅^{T}=2.0, a T₅⁰=118.1° C. Similar to above, the first Gaussian term that describes the nearly temperature-independent slope behavior within the pre-softening and post-melting regions was excluded in determination of the crystalline fractions melted within each one of the temperature intervals.

The first-order log-derivative of elastic shear modulus data (|dlogG′/dT| in ° C.⁻¹) for Comparative Example 2 (see FIG. 2c) was fitted with a sum of 3 (or n+2 where n is the number of peaks observed in the |dlogG′/dT| function when plotted as a function of temperature) Gaussian functions. The fitted sum of Gaussian functions had a first term with a G₁=3.73, a δ₁^{T}=121.8, a T₁⁰=16.5° C.; a second term with a G₂=0.93, a δ₂^{T}=12.7, a T₂⁰=77.3° C.; and a third term with a G₃=0.56, a δ₃^{T}=4.8, a T₃⁰=79.5° C. Similar to Example 1 and Comparative Example 1, the first Gaussian term that describes the nearly temperature-independent slope behavior within the pre-softening and post-melting regions was excluded in determination of the crystalline fractions melted within each one of the temperature intervals.

The first-order log-derivative of elastic shear modulus data (|dlogG′/dT| in ° C.⁻¹) for Comparative Example 3 (see FIG. 2d) was fitted with a sum of 3 (or n+2 where n is the number of peaks observed in the |dlogG′/dT| function when plotted as a function of temperature) Gaussian functions. The fitted sum of Gaussian functions had a first term with a G₁=4.39, a δ₁^{T}=117.4, a T₁⁰=12.0° C.; a second term with a G₂=1.0, a δ₂^{T}=11.8, a T₂⁰=85.5° C.; and a third term with a G₃=0.53, a δ₃^{T}=4.1, a T₃⁰=89.5° C. The first Gaussian term that describes the nearly temperature-independent slope behavior within the pre-softening and post-melting regions was excluded in determination of the crystalline fractions melted within each one of the temperature intervals.

The first-order log-derivative of elastic shear modulus data (|dlogG′/dT| in ° C.⁻¹) for Comparative Example 4 (see FIG. 2e) was fitted with a sum of 3 (or n+2 where n is the number of peaks observed in the |dlogG′/dT| function when plotted as a function of temperature) Gaussian functions. The fitted sum of Gaussian functions had a first term with a G₁=3.98, a δ₁^{T}=173.4, a T₁⁰=40.5° C.; a second term with a G₂=0.46, a δ₂^{T}=6.3, a T₂⁰=63.5° C.; and a third term with a G₃=0.38, a δ₃^{T}=16.2, a T₃⁰=79.5° C. The first Gaussian term that describes the nearly temperature-independent slope behavior within the pre-softening and post-melting regions was excluded in determination of the crystalline fractions melted within each one of the temperature intervals.

As tabulated in Table 4, It was clearly observable that Example 1 relative to the Comparative Example 1 through 4 had a differentiated softening profile with (a) from about 1 percent to about 3 percent of a crystalline fraction melting in the temperature range from 50° C. to the RSP of said ethylene/α-olefin copolymer; (b) from 60 percent to 80 percent of a crystalline fraction melting in the temperature range from the RSP of said ethylene/α-olefin copolymer to RSP+40° C.; and (c) from 10 percent to 20 percent of fraction melting in the temperature range from RSP+40° C. to RSP+70° C.

The content of crystalline fractions melting within the RSP+40° C. to RSP+70° C. interval could be further augmented by adding a small amount of a high-density polyethylene material. In this section, a series of polymer blends were made by melt blending the ethylene/α-olefin copolymer product of Example 1 and two commercially available high-density compositions available from NOVA Chemicals Corporation; namely: HB-W355-A with a high-load melt index (I₂₁) of 3.1 dg/min and a density of 0.9550 g/cm³ and HB-W952-A with a high-load melt index (I₂₁) of 10.0 dg/min and a density of 0.9515 g/cm³. The blend compositions and their rheological softening characteristics are shown in Table 4. It is noticeable that, while blending the ethylene/α-olefin copolymer product of Example 1 with a high-density component within the ranges disclosed in Table 4 had no meaningful impact on the RSP of final polymer blend, the percent of crystalline fractions melting within the RSP+40° C. to RSP+70° C. interval was increase to values within the 20 to 30 percent range. This increase was accompanied by a decrease in the percent of the fraction melted within the 50° C. to RSP and RSP to RSP+40° C. intervals.

Example 1 and the high-density components had a complex viscosity ratio of 21.9 (ratio of |η*|^{HB-W355-A} to |η*|^{Ex.1}) and 4.2 (ratio of |η*|^{HB-W952-A} to |η*|^{Ex.1}), respectively (determined at a |G*| of 10 kPa). One notices that the polymer blend series with a lower complex viscosity ratio at a |G*| of 10 kPa showed a higher content of crystalline fractions melting within the RSP+40° C. to RSP+70° C. range despite lower density of HB-W952-A. This indicates that a better quality of dispersion was achieved in the cased of Ex.1/HB-W952-A combination with a lower ratio of the dispersed phase (HB-W952-A) viscosity to that of the matrix phase (Ex. 1).

As detailed above, the pilot scale Example 1 and Comparative Example 1 were pelletized after a two-stage process for solvent recovery. Produced pellets were spheroidal in shape and had an average diameter of about 2 millimeters with an average of about 40 pellets per 1 gram of the pelletized ethylene/α-olefin copolymer product. The pelletized ethylene/α-olefin copolymer product prepared from Example 1 (the pelletized product is referred to as Example 1P) and the pelletized ethylene/α-olefin copolymer product prepared from Comparative Example 1 (the pelletized product is referred to as Comparative Example 1P) together with the pellets from the commercially available Comparative Examples 2 through 4 (referred to as Comparative Examples 2P through 4P) were further tested in a direct compaction test on pellets using a rotational rheometer at a constant normal force of 9.6±0.5 N (a pressure of 20.4 kPa) which was applied by an upper plate attached to the rheometer's torque transducer. The upper plate had a dimeter of 25 millimeters. Pellets were loaded at room temperature on rheometer's lower plate having the same diameter as the upper plate. The lower plate was surrounded by a cylindrical support ring which was in contact with the lower plate only at the lateral area of the lower plate. A pre-weighted pellets sample was loaded into the cavity formed by the lower plate and the internal lateral area of the support ring to develop a pellets bed with a height of 9 to 12 milliliters above the rheometers lower plate.

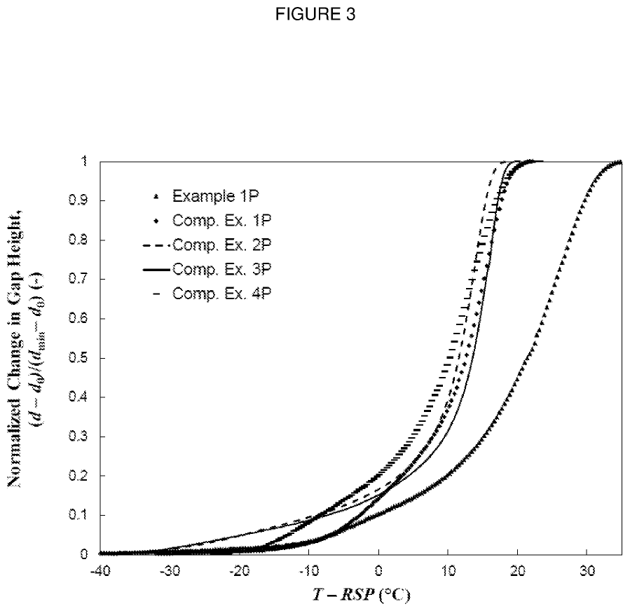

After loading the pellets sample, the upper plate was lowered and brought into contact with the pellets bed to reach a normal of 9.6±0.5 N and the rheometer oven was closed and set to 30° C. After 30 minutes, the oven temperature was raised linearly from 30° C. to 140° C. at a heating rate of 0.5 K per minute while the pellets bed height was monitored as a function of temperature. In this test, pellets gradually deformed and filled the inter-pellet space under a constant load which densified the pellets bed leading to a smaller recorded gap height. Results of such testing procedure is depicted in FIG. 3 for Example 1 and Comparatives 1through 4. FIG. 3 displays a normalized change in the bed's gap height defined according to (d−d₀)/(dₘᵢₙ−d₀), where d₀ was the initial gap height of the bed having a value from 9 to 12 millimeters, d was the instantaneous gap height at any given temperature, and dₘᵢₙ was the minimum gap height observed during the experiment corresponding to a point where pellets deformed and fully filled the inter-pellets space. The normalized gap height in FIG. 3 was plotted as a function of T−RSP for a fair comparison between Examples by removing the impact of resins' density.

It is noticeable that, at about a T−RSP of −35 to −30° C. the variation in normalized gap height of Comparative Examples 2P-4P featured an initial increase within the first followed by a much faster rate of change at higher T−RSP values. In the case of Example 1P and the Comparative Example 1P, the normalized gap height started a slow increase at a T−RSP of about −25° C. After the initial slow increase, the curve observed for the Comparative Example 1P underwent a drastic increase at a T−RSP of about −5° C. approaching toward the cluster of curves formed by Comparative Examples 2P-4P. This is contrary to the observed trend for Example 1P where only a finite amount of pellets deformation and space-filling is permitted within a range of −10<T−RSP<10. Example 1P can be further differentiated from Comparative Examples 1P through 4P based on the T−RSP value at which complete space filling was achieved. As can be seen, complete space filling was achieved at a T−RSP of about +35° C. in the case of Example 1P which was at least ˜22° C. above that of the Comparative pellets. One advantage for the observed delayed deformation in the case of the pelletized ethylene/α-olefin copolymer product of Example 1P is its devolatilization at a temperature closer to its RSP with no major risk of blocking the devolatilization vessel.

Without wishing to be limited by any theory or mechanism, it can be hypothesized that the observed delayed softening in the case of pelletized ethylene/α-olefin copolymer product of Example 1P is the direct result of a percolation-like transition and formation of a three-dimensional network by interconnected crystallites of the first and the second high-density fractions having a melting temperature well above the RSP of the ethylene/α-olefin copolymer product. Long-and short-range interconnectivity in this network was provided by primary tie molecules (e.g., high-M_{w} species of the first high-density fraction having a M_{w,1}^{HD}/M_{w}>2folding in more than one crystallite) and by the secondary tie molecules given the optimized overall M_{w} and M_{z} of the ethylene/α-olefin copolymer product.

TABLE 4
Rheological Softening Point (RSP) and Percent of the Crystalline
Fractions Melted in Each One of the Temperature Intervals of from
50° C. to RSP, from RSP to RSP + 40° C. and from RSP + 40° C.
to RSP to 70° C. of Example 1, Comparative Examples 1-4,
and Polymer Blends B11 through B22

| | | 50-RSP | RSP- | RSP + 40- |
|---|---|---|---|---|
| | RSP | fraction | RSP + 40 | RSP + 70 |
| | (° C.) | (%) | fraction (%) | fraction (%) |
| Ex. 1 | 65.2 | 3.8 | 78.0 | 18.2 |
| Comp. Ex. 1 | 70.2 | 8.6 | 86.1 | 5.3 |
| Comp. Ex. 2 | 68.3 | 11.6 | 87.6 | 0.8 |
| Comp. Ex. 3 | 70.4 | 6.7 | 92.2 | 1.2 |
| Comp. Ex. 4 | 54.6 | 6.0 | 90.4 | 3.6 |
| Polymer Blend B11* | 64.1 | 2.9 | 75.8 | 21.3 |
| Polymer Blend B12^{†} | 63.7 | 2.8 | 73.0 | 24.1 |
| Polymer Blend B13^{‡} | 63.8 | 2.6 | 72.8 | 24.6 |
| Polymer Blend B21^{§} | 65.4 | 1.9 | 70.0 | 28.1 |
| Polymer Blend B22^{¶} | 64.8 | 2.2 | 67.9 | 29.9 |

*Example 1 + 0.5 wt % HB-W355-A
^{†}Example 1 + 1.0 wt % HB-W355-A
^{‡}Example 1 + 2.0 wt % HB-W355-A
^{§}Example 1 + 1.0 wt % HB-W952-A
^{¶}Example 1 + 2.0 wt % HB-W952-A

Non-limiting embodiments of the present disclosure include the following:

### Embodiment A

An ethylene/α-olefin copolymer product having: a density from 0.865 to 0.905 g/cm³ as measured by ASTM D1505; a melt index MI₂ from 0.3 to 1.5 dg/min as measured by ASTM D1238 at a temperature of 190° C. using a 2.16 kg load; a weight-average molecular weight M_{w} of from 95 to 140 kg/mol as measured by conventional size exclusion chromatography; and a z-average molecular weight M_{z} of 220 to 280 kg/mol as measured by conventional size exclusion chromatography;

wherein said ethylene/α-olefin copolymer product comprises from 0.5 to 2 weight percent of a first high-density fraction characterized as having: a ΔSCB₁ of less than −10 branch point per 1000 carbons, wherein said ΔSCB₁ is defined according to SCB₁^{HD}−SCB, wherein SCB₁^{HD} is a short chain branching content of said first high-density fraction and SCB is an overall short chain branching content of said ethylene/α-olefin copolymer product as measured by Fourier transform infrared (FTIR) spectroscopy according to ASTM D6645-01 (2001); and a weight-average molecular weight M_{w,1}^{HD}, wherein said weight-average molecular weight of said first high-density fraction M_{w,1}^{HD} and said weight average molecular weight of said ethylene/α-olefin copolymer product M_{w} satisfy the inequality of M_{w,1}^{HD}/M_{w}>2.

### Embodiment B

The ethylene/α-olefin copolymer product of Embodiment A wherein said SCB₁^{HD} and M_{w,1}^{HD} of the first high-density fraction, respectively, satisfy the inequalities of ΔSCB₁>−20 branch point per 1000 carbons and M_{w,1}^{HD}/M_{w}<3.

### Embodiment C

The ethylene/α-olefin copolymer product of Embodiment A or B wherein said ethylene/α-olefin copolymer product comprises from 0.3 to 0.8 weight percent of a second high-density fraction characterized as having: a ΔSCB₂ of less than −10 branch point per 1000 carbons, wherein said ΔSCB₂ is defined according to SCB₂^{HD}−SCB, wherein SCB₂^{HD} is a short chain branching content of said second high-density fraction and SCB is said overall short chain branching content of said ethylene/α-olefin copolymer product as measured by Fourier transform infrared (FTIR) spectroscopy according to ASTM D6645-01 (2001); and a weight-average molecular weight M_{w,2}^{HD}, wherein said weight-average molecular weight of said second high-density fraction M_{w,2}^{HD} and said weight average molecular weight of said ethylene/α-olefin copolymer product M_{w} satisfies the inequality of 0.8<M_{w,2}^{HD}/M_{w}<1.2.

### Embodiment D

The ethylene/α-olefin copolymer product of Embodiment A, B or C wherein said ethylene/α-olefin copolymer product has a rheological softening point (RSP) from greater than or equal to 55° C. to less than or equal to 95° C., wherein said ethylene/α-olefin copolymer product comprises the following crystalline fractions in a dynamic temperature sweep test: from about 1 percent to about 3 percent of a crystalline fraction melting in the temperature range from 50° C. to the RSP of said ethylene/α-olefin copolymer product; from 60 percent to 80 percent of a crystalline fraction melting in the temperature range from the RSP of said ethylene/α-olefin copolymer product to RSP+40° C.; and from 15 percent to 30 percent of a crystalline fraction melting in the temperature range from RSP+40° C. to RSP+70° C.

### Embodiment E

The ethylene/α-olefin copolymer product of Embodiment A, B, or C wherein said ethylene/α-olefin copolymer product has a rheological softening point (RSP) from greater than or equal to 55° C. to less than or equal to 95° C., wherein said ethylene/α-olefin copolymer product comprises the following crystalline fractions in a dynamic temperature sweep test: from about 1 percent to about 5 percent of a crystalline fraction melting in the temperature range from 50° C. to the RSP of said ethylene/α-olefin copolymer product; from 60 percent to 80 percent of a crystalline fraction melting in the temperature range from the RSP of said ethylene/α-olefin copolymer product to RSP+40° C.; and from 10 percent to 20 percent of a crystalline fraction melting in the temperature range from RSP+40° C. to RSP+70° C.

### Embodiment F

The ethylene/α-olefin copolymer product of Embodiment A, B, C, D or E wherein said ethylene/α-olefin copolymer product has a density of less than or equal to 0.902 g/cm³ as measured by ASTM D1505.

### Embodiment G

The ethylene/α-olefin copolymer product of Embodiment A, B, C, D, or E wherein said ethylene/α-olefin copolymer product has a density of less than or equal to 0.900 g/cm³ as measured by ASTM D1505

### Embodiment H

The ethylene/α-olefin copolymer product of Embodiment A, B, C, D, E, F or G wherein said melt index MI₂ of said ethylene/α-olefin copolymer product is from 0.3 to 0.8 dg/min as measured by ASTM D1238 at a temperature of 190° C. using a 2.16 kg load.

### Embodiment I

The ethylene/α-olefin copolymer product of Embodiment A, B, C, D, E, F, G or H wherein said ethylene/α-olefin copolymer product is characterized as having a zero-shear viscosity (η₀) at 190° C. which satisfies the inequality of

$$log [ {{η}_{0} ( \frac{{M}_{z}}{{M}_{w}} )}^{0.4} ] - log ( {η}_{0}^{lin} ) > 0.156 ,$$

wherein M_{z}/M_{w} is the ratio of z-average molecular weight and weight-average molecular weight as determined by conventional size exclusion chromatography, and wherein log(η₀^{lin}) is defined according to the following double power-law equation:

$$log ( {η}_{0}^{lin} ) = α log ( {m}_{b} ) + β log ( {M}_{w}^{LS} ) + K$$

wherein α=−3.8326, δ=3.6954, K=−10.3477, m) is the molecular weight per backbone bond which is calculated in units of g/mol according to m_{b}=[n_{c}M_{w}^{como}+28(1−n_{c})]/2, wherein n_{c} is the mole fraction of the α-olefin comonomer measured by Fourier transform infrared (FTIR) spectroscopy according to ASTM D6645-01 (2001), M_{w}^{como} is the molecular weight of the α-olefin comonomer in g/mol, and M_{w}^{LS} is the absolute weight-average molecular weight as determined by light scattering size exclusion.

### Embodiment J

The ethylene/α-olefin copolymer product of Embodiment A, B, C, D, E, F, G, H or I wherein said ethylene/α-olefin copolymer product is made in a continuous solution phase polymerization process with a single site catalyst system in two or more reactors, wherein said single site catalyst system comprises a metallocene catalyst having the formula (I):

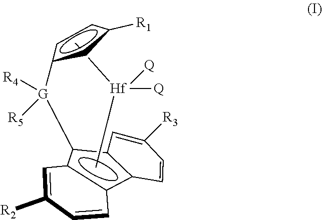

wherein G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

### Embodiment K

A pelletized ethylene/α-olefin copolymer product comprising an ethylene/α-olefin copolymer product having: a density from 0.865 to 0.905 g/cm³ as measured by ASTM D1505; a melt index MI₂ from 0.3 to 1.5 dg/min as measured by ASTM D1238 at a temperature of 190° C. using a 2.16 kg load; a weight-average molecular weight M_{w} of from 95 to 140 kg/mol as measured by conventional size exclusion chromatography; and a z-average molecular weight M_{z} of 220 to 280 kg/mol as measured by conventional size exclusion chromatography; wherein said ethylene/α-olefin copolymer product comprises from 0.5 to 2 weight percent of a first high-density fraction characterized as having: a ΔSCB₁ of less than −10 branch point per 1000 carbons, wherein said ΔSCB₁ is defined according to SCB₁^{HD}−SCB, wherein SCB₁^{HD} is a short chain branching content of said first high-density fraction and SCB is an overall short chain branching content of said ethylene/α-olefin copolymer product as measured by Fourier transform infrared (FTIR) spectroscopy according to ASTM D6645-01 (2001); and a weight-average molecular weight M_{w,1}^{HD}, wherein said weight-average molecular weight of said first high-density fraction M_{w,1}^{HD} and said weight average molecular weight of said ethylene/α-olefin copolymer product M_{w} satisfy the inequality of M_{w,1}^{HD}/M_{w}>2.

### Embodiment L

The pelletized ethylene/α-olefin copolymer product of Embodiment K wherein said SCB₁^{HD} and M_{w,1}^{HD} of the first high-density fraction, respectively, satisfy the inequalities of SCB₁^{HD}−SCB>−20 branch point per 1000 carbons and M_{w,1}^{HD}/M_{w}<3.

### Embodiment M

The pelletized ethylene/α-olefin copolymer product of Embodiment K or L wherein said ethylene/α-olefin copolymer product comprises from 0.4 to 0.8 weight percent of a second high-density fraction characterized as having: a ΔSCB₂ of less than −10 branch point per 1000 carbons, wherein said ΔSCB₂ is defined according to SCB₂^{HD}−SCB, wherein SCB₂^{HD is a short chain branching content of said second high-density fraction and SCB is said overall short chain branching content of said ethylene/α-olefin copolymer product as measured by Fourier transform infrared (FTIR) spectroscopy according to ASTM D}6645-01 (2001); and a weight-average molecular weight M_{w,2}^{HD}, wherein said weight-average molecular weight of said second high-density fraction M_{w,2}^{HD} and said weight average molecular weight of said ethylene/α-olefin copolymer product M_{w} satisfies the inequality of 0.8<M_{w,2}^{HD}/M_{w}<1.2.

### Embodiment N

The pelletized ethylene/α-olefin copolymer product of Embodiment K, L, or M wherein said ethylene/α-olefin copolymer product has a rheological softening point (RSP) from greater than or equal to 55° C. to less than or equal to 95° C., wherein said ethylene/α-olefin copolymer composition comprises the following crystalline fractions in a dynamic temperature sweep test: from about 1 percent to about 5 percent of a crystalline fraction melting in the temperature range from 50° C. to the RSP of said ethylene/α-olefin copolymer product; from 60 percent to 80 percent of a crystalline fraction melting in the temperature range from the RSP of said ethylene/α-olefin copolymer product to RSP+40° C.; and from 10 percent to 20 percent of a crystalline fraction melting in the temperature range from RSP+40° C. to RSP+70° C.

### Embodiment O

The pelletized ethylene/α-olefin copolymer product of Embodiment K, L, M or N wherein said ethylene/α-olefin copolymer product has a density of less than or equal to 0.902 g/cm³ as measured by ASTM D1505.

### Embodiment P

The pelletized ethylene/α-olefin copolymer product of Embodiment K, L, M or N wherein said ethylene/α-olefin copolymer product has a density of less than or equal to 0.900 g/cm³ as measured by ASTM D1505.

### Embodiment Q

The pelletized ethylene/α-olefin copolymer product of Embodiment K, L, M, N, O or P wherein said melt index MI2 of said ethylene/α-olefin copolymer product is from 0.3 to 0.8 dg/min as measured by ASTM D1238 at a temperature of 190° C. using a 2.16 kg load.

### Embodiment R

The pelletized ethylene/α-olefin copolymer product of Embodiment K, L, M, N, O, P or Q wherein said ethylene/α-olefin copolymer product is characterized as having a zero-shear viscosity (η₀) at 190° C. which satisfies the inequality of

$$log [ {{η}_{0} ( \frac{{M}_{z}}{{M}_{w}} )}^{0.4} ] - log ( {η}_{0}^{lin} ) > 0.156 ,$$

wherein M_{z}/M_{w} is the ratio of z-average molecular weight and weight-average molecular weight as determined by conventional size exclusion chromatography, and wherein log(η₀^{lin}) is defined according to the following double power-law equation:

$$log ( {η}_{0}^{lin} ) = α log ( {m}_{b} ) + β log ( {M}_{w}^{LS} ) + K$$

wherein α=−3.8326, δ=3.6954, K=−10.3477, m_{b} is the molecular weight per backbone bond which is calculated in units of g/mol according to m_{b}=[n_{c}M_{w}^{como}+28(1−n_{c})]/2, wherein n_{c} is the mole fraction of the α-olefin comonomer measured by Fourier transform infrared (FTIR) spectroscopy according to ASTM D6645-01 (2001), M_{w}^{como} is the molecular weight of the α-olefin comonomer in g/mol, and M_{w}^{LS} is the absolute weight-average molecular weight as determined by light scattering size exclusion.

### Embodiment S

A polymer blend comprising from 97 to 99.5 weight percent of the ethylene/α-olefin copolymer product of Embodiment A, B, C, D, E, F, G, H, I or J and from 0.5 to 3 weight percent of a high-density polyethylene, wherein the high-density polyethylene has a density from 0.950 to 0.960 g/cm³ and a high load melt index (I₂₁) from 5 to 15 dg/min.

### Embodiment T

The polymer blend of Embodiment S wherein the ethylene/α-olefin copolymer product and the high-density polyethylene, respectively, have complex viscosities |η*|¹ and |η*|² at a complex modulus |G*| of 10 kPa satisfying the inequality of 1< |η*|²/|η*|¹<10.

### Embodiment U

The polymer blend of Embodiment S wherein the ethylene/α-olefin copolymer product and the high-density polyethylene, respectively, have complex viscosities |η*|¹ and |η*|² at a complex modulus |G*| of 10 kPa satisfying the inequality of 1< |η*|²/|η*|¹<8.

### Embodiment V

The polymer blend of Embodiment S, T or U wherein the polymer blend comprises the following crystalline fractions in a dynamic temperature sweep test: from about 1 percent to about 3 percent of a crystalline fraction melting in the temperature range from 50° C. to the RSP of the polymer blend; from 60 percent to 80 percent of a crystalline fraction melting in the temperature range from the RSP of said polymer blend to RSP+40° C.; and from 15 percent to 30 percent of a crystalline fraction melting in the temperature range from RSP+40° C. to RSP+70° C.

### Industrial Applicability

Disclosed herein is an ethylene/α-olefin copolymer product with a wide variety of industrial uses; a non-limiting example is preparation of a sealant layer in a multilayer flexible packaging film.

1. An ethylene/α-olefin copolymer product having:
(a) a density from 0.865 to 0.905 g/cm³ as measured by ASTM D1505;
(b) a melt index MI₂ from 0.3 to 1.5 dg/min as measured by ASTM D1238 at a temperature of 190° C. using a 2.16 kg load;
(c) a weight-average molecular weight M_{w} of from 95 to 140 kg/mol as measured by conventional size exclusion chromatography; and
(d) a z-average molecular weight M_{z} of 220 to 280 kg/mol as measured by conventional size exclusion chromatography;
wherein said ethylene/α-olefin copolymer product comprises from 0.5 to 2 weight percent of a first high-density fraction characterized as having:
i) a ΔSCB₁ of less than −10 branch point per 1000 carbons, wherein said ΔSCB₁ is defined according to SCB₁^{HD}−SCB, wherein SCB₁^{HD} is a short chain branching content of said first high-density fraction and SCB is an overall short chain branching content of said ethylene/α-olefin copolymer product as measured by Fourier transform infrared (FTIR) spectroscopy according to ASTM D6645-01 (2001); and
ii) a weight-average molecular weight M_{w,1}^{HD}, wherein said weight-average molecular weight of said first high-density fraction M_{w,1}^{HD} and said weight average molecular weight of said ethylene/α-olefin copolymer product M_{w} satisfy the inequality of M_{w,1}^{HD}/M_{w}>2.

2. The ethylene/α-olefin copolymer product of claim 1, wherein said SCB₁^{HD} and M_{w,1}^{HD} of the first high-density fraction, respectively, satisfy the inequalities of ΔSCB₁>−20 branch point per 1000 carbons and M_{w,1}^{HD}/M_{w}<3.

3. The ethylene/α-olefin copolymer product of claim 1, wherein said ethylene/α-olefin copolymer product comprises from 0.3 to 0.8 weight percent of a second high-density fraction characterized as having:
i) a ΔSCB₂ of less than −10 branch point per 1000 carbons, wherein said ΔSCB₂ is defined according to SCB₂^{HD}−SCB, wherein SCB₂^{HD} is a short chain branching content of said second high-density fraction and SCB is said overall short chain branching content of said ethylene/α-olefin copolymer product as measured by Fourier transform infrared (FTIR) spectroscopy according to ASTM D6645-01 (2001); and
ii) a weight-average molecular weight M_{w,2}^{HD}, wherein said weight-average molecular weight of said second high-density fraction M_{w,2}^{HD} and said weight average molecular weight of said ethylene/α-olefin copolymer product M_{w} satisfies the inequality of 0.8<M_{w,2}^{HD}/M_{w}<1.2.

4. The ethylene/α-olefin copolymer product of claim 1, wherein said ethylene/α-olefin copolymer product has a rheological softening point (RSP) from greater than or equal to 55° C. to less than or equal to 95° C., wherein said ethylene/α-olefin copolymer product comprises the following crystalline fractions in a dynamic temperature sweep test:
(a) from about 1 percent to about 5 percent of a crystalline fraction melting in the temperature range from 50° C. to the RSP of said ethylene/α-olefin copolymer product;
(b) from 60 percent to 80 percent of a crystalline fraction melting in the temperature range from the RSP of said ethylene/α-olefin copolymer product to RSP+40° C.; and
(c) from 10 percent to 20 percent of a crystalline fraction melting in the temperature range from RSP+40° C. to RSP+70° C.

5. The ethylene/α-olefin copolymer product of claim 1, wherein said ethylene/α-olefin copolymer product has a density of less than or equal to 0.902 g/cm³ as measured by ASTM D1505.

6. The ethylene/α-olefin copolymer product of claim 1, wherein said ethylene/α-olefin copolymer product has a density of less than or equal to 0.900 g/cm³ as measured by ASTM D1505.

7. The ethylene/α-olefin copolymer product of claim 1, wherein said melt index MI₂ of said ethylene/α-olefin copolymer product is from 0.3 to 0.8 dg/min as measured by ASTM D1238 at a temperature of 190° C. using a 2.16 kg load.

8. The ethylene/α-olefin copolymer product of claim 1, wherein said ethylene/α-olefin copolymer product is characterized as having a zero-shear viscosity (η₀) at 190° C. which satisfies the inequality of
$$log [ {{η}_{0} ( \frac{{M}_{z}}{{M}_{w}} )}^{0.4} ] - log ( {η}_{0}^{lin} ) > 0.156 ,$$
wherein M_{z}/M_{w} is the ratio of z-average molecular weight and weight-average molecular weight as determined by conventional size exclusion chromatography, and wherein log(η₀^{lin}) is defined according to the following double power-law equation:
$$log ( {η}_{0}^{lin} ) = α log ( {m}_{b} ) + β log ( {M}_{w}^{LS} ) + K$$
wherein α=−3.8326, δ=3.6954, K=−10.3477, m_{b} is the molecular weight per backbone bond which is calculated in units of g/mol according to m_{b}=[n_{c}M_{w}^{como}+28(1−n_{c})]/2, wherein n_{c} is the mole fraction of the α-olefin comonomer measured by Fourier transform infrared (FTIR) spectroscopy according to ASTM D6645-01 (2001), M_{w}^{como} is the molecular weight of the α-olefin comonomer in g/mol, and M_{w}^{LS} is the absolute weight-average molecular weight as determined by light scattering size exclusion.

9. The ethylene/α-olefin copolymer product of claim 1, wherein said ethylene/α-olefin copolymer product is made in a continuous solution phase polymerization process with a single site catalyst system in two or more reactors, wherein said single site catalyst system comprises a metallocene catalyst having the formula (I): 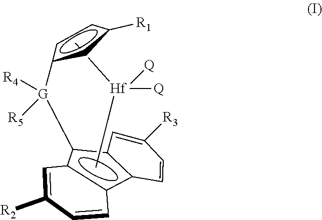
wherein G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

10. A polymer blend comprising from 97 to 99.5 weight percent of the ethylene/α-olefin copolymer product of claim 1 and from 0.5 to 3 weight percent of a high-density polyethylene, wherein the high-density polyethylene has a density from 0.950 to 0.960 g/cm³ and a high load melt index (I₂₁) from 5 to 15 dg/min.

11. The polymer blend of claim 10, wherein the ethylene/α-olefin copolymer product and the high-density polyethylene, respectively, have complex viscosities |η*|¹ and |η*|² at a complex modulus |G*| of 10 kPa satisfying the inequality of 1< |η*|²/|η*|¹<10.

12. The polymer blend of claim 10, wherein the ethylene/α-olefin copolymer product and the high-density polyethylene, respectively, have complex viscosities |η*|¹ and |η*|² at a complex modulus |G*| of 10 kPa satisfying the inequality of 1< |η*|²/|η*|¹<8.

13. The polymer blend of claim 10, wherein the polymer blend comprises the following crystalline fractions in a dynamic temperature sweep test:
(d) from about 1 percent to about 3 percent of a crystalline fraction melting in the temperature range from 50° C. to the RSP of the polymer blend;
(e) from 60 percent to 80 percent of a crystalline fraction melting in the temperature range from the RSP of said polymer blend to RSP+40° C.; and
(f) from 15 percent to 30 percent of a crystalline fraction melting in the temperature range from RSP+40° C. to RSP+70° C.

14. A pelletized ethylene/α-olefin copolymer product comprising an ethylene/α-olefin copolymer product having:
(a) a density from 0.865 to 0.905 g/cm3 as measured by ASTM D1505;
(b) a melt index MI2 from 0.3 to 1.5 dg/min as measured by ASTM D1238 at a temperature of 190° C. using a 2.16 kg load;
(c) a weight-average molecular weight M_{w} of from 95 to 140 kg/mol as measured by conventional size exclusion chromatography; and
(d) a z-average molecular weight M_{z} of 220 to 280 kg/mol as measured by conventional size exclusion chromatography;
wherein said ethylene/α-olefin copolymer product comprises from 0.5 to 2 weight percent of a first high-density fraction characterized as having:
i) a ΔSCB₁ of less than −10 branch point per 1000 carbons, wherein said ΔSCB₁ is defined according to SCB₁^{HD}−SCB, wherein SCB₁^{HD} is a short chain branching content of said first high-density fraction and SCB is an overall short chain branching content of said ethylene/α-olefin copolymer product as measured by Fourier transform infrared (FTIR) spectroscopy according to ASTM D6645-01 (2001); and
ii) a weight-average molecular weight M_{w,1}^{HD}, wherein said weight-average molecular weight of said first high-density fraction M_{w,1}^{HD} and said weight average molecular weight of said ethylene/α-olefin copolymer product M_{w} satisfy the inequality of M_{w,1}^{HD}/M_{w}>2.

15. The pelletized ethylene/α-olefin copolymer product of claim 14, wherein said SCB₁^{HD} and M_{w,1}^{HD} of the first high-density fraction, respectively, satisfy the inequalities of SCB₁^{HD}−SCB>−20 branch point per 1000 carbons and M_{w,1}^{HD}/M_{w}<3.

16. The pelletized ethylene/α-olefin copolymer product of claim 14, wherein said ethylene/α-olefin copolymer product comprises from 0.4 to 0.8 weight percent of a second high-density fraction characterized as having:
i) a ΔSCB₂ of less than −10 branch point per 1000 carbons, wherein said ΔSCB₂ is defined according to SCB₂^{HD}−SCB, wherein SCB₂^{HD} is a short chain branching content of said second high-density fraction and SCB is said overall short chain branching content of said ethylene/α-olefin copolymer product as measured by Fourier transform infrared (FTIR) spectroscopy according to ASTM D6645-01 (2001); and
ii) a weight-average molecular weight M_{w,2}^{HD}, wherein said weight-average molecular weight of said second high-density fraction M_{w,2}^{HD} and said weight average molecular weight of said ethylene/α-olefin copolymer product M_{w} satisfies the inequality of 0.8<M_{w,2}^{HD}/M_{w}<1.2.

17. The pelletized ethylene/α-olefin copolymer product of claim 14, wherein said ethylene/α-olefin copolymer product has a rheological softening point (RSP) from greater than or equal to 55° C. to less than or equal to 95° C., wherein said ethylene/α-olefin copolymer composition comprises the following crystalline fractions in a dynamic temperature sweep test:
(a) from about 1 percent to about 5 percent of a crystalline fraction melting in the temperature range from 50° C. to the RSP of said ethylene/α-olefin copolymer product;
(b) from 60 percent to 80 percent of a crystalline fraction melting in the temperature range from the RSP of said ethylene/α-olefin copolymer product to RSP+40° C.; and
(c) from 10 percent to 20 percent of a crystalline fraction melting in the temperature range from RSP+40° C. to RSP+70° C.

18. The pelletized ethylene/α-olefin copolymer product of claim 14, wherein said ethylene/α-olefin copolymer product has a density of less than or equal to 0.902 g/cm³ as measured by ASTM D1505.

19. The pelletized ethylene/α-olefin copolymer product of claim 14, wherein said ethylene/α-olefin copolymer product has a density of less than or equal to 0.900 g/cm³ as measured by ASTM D1505.

20. The pelletized ethylene/α-olefin copolymer product of claim 14, wherein said melt index MI₂ of said ethylene/α-olefin copolymer product is from 0.3 to 0.8 dg/min as measured by ASTM D1238 at a temperature of 190° C. using a 2.16 kg load.

21. The pelletized ethylene/α-olefin copolymer product of claim 14, wherein said ethylene/α-olefin copolymer product is characterized as having a zero-shear viscosity (η₀) at 190° C. which satisfies the inequality of
$$log [ {{η}_{0} ( \frac{{M}_{z}}{{M}_{w}} )}^{0.4} ] - log ( {η}_{0}^{lin} ) > 0.156 ,$$
wherein M_{z}/M_{w} is the ratio of z-average molecular weight and weight-average molecular weight as determined by conventional size exclusion chromatography, and wherein log(η₀^{lin}) is defined according to the following double power-law equation:
$$log ( {η}_{0}^{lin} ) = α log ( {m}_{b} ) + β log ( {M}_{w}^{LS} ) + K$$
wherein α=−3.8326, β=3.6954, K=−10.3477, m_{b} is the molecular weight per backbone bond which is calculated in units of g/mol according to m_{b}=[n_{c}M_{w}^{como}+28(1−n_{c})]/2, wherein n_{c} is the mole fraction of the α-olefin comonomer measured by Fourier transform infrared (FTIR) spectroscopy according to ASTM D6645-01 (2001), M_{w}^{como} is the molecular weight of the α-olefin comonomer in g/mol, and M_{w}^{LS} is the absolute weight-average molecular weight as determined by light scattering size exclusion.
